(19) United States
(12) Patent Application Publication
(10) Pub. No.: US 2026/0186926 A1
(43) Pub. Date: Jul. 2, 2026

(54) SEAMLESS UPGRADE FOR A CLUSTERED FILE SYSTEM

(71) Applicant: Dell Products L.P., Round Rock, TX (US)

(72) Inventors: Viral Kirtikumar Mehta, JamKhambhalia (IN); Nachiket Vilasrao Ghorpade, Pune (IN); Vikas Chaudhary, Pune (IN); Donna Barry Lewis, Holly Springs, NC (US)

(21) Appl. No.: 19/007,401

(22) Filed: Dec. 31, 2024

(51) Int. Cl. G06F 11/20; G06F 11/14

(52) U.S. Cl. CPC G06F 11/203; G06F 11/1453; G06F 11/1464

(57) ABSTRACT

Forechannel connections are established from client-side deduplication libraries to a namespace node of a set of namespace nodes formed as a cluster. The namespace nodes are responsible for namespace operations on files managed by a deduplication filesystem. The forechannel connections are responsible for carrying file data between the client-side deduplication libraries and the namespace node. Server-initiated connections are established from the namespace node to the client-side deduplication libraries. The server-initiated connections are responsible for carrying instructions from the namespace node to the client-side deduplication libraries. While a transfer of file data is in progress, the client-side deduplication libraries are instructed over the server-initiated connections to failover the transfer to one or more other namespace nodes. After the failover, the namespace node is upgraded.

### CROSS-REFERENCE TO RELATED APPLICATIONS

This application is related to co-pending U.S. patent applications (attorney docket numbers 141668.01 (DL1.547U) and 141766.01 (DL1.551U)), filed concurrently herewith, and which are incorporated herein by reference for all purposes.

### TECHNICAL FIELD

The present invention relates generally to information processing systems, and more particularly to large scale file systems.

### BACKGROUND

Companies rely on backup storage systems to safeguard critical business data from loss due to hardware failures, human error, natural disasters, cyberattacks, and so forth. Clients are the individual computers, servers, or devices that contain data to be backed up. The clients may run applications such as backup applications that identify data for backup to a backup server. Occasionally, there is a need to conduct an upgrade of the server. The upgrades may be to provide new features, bug and security fixes, performance improvements, and so forth.

Performing an upgrade, however, can be disruptive because the upgrade typically requires the server to be taken offline for period of time while the upgrade is in progress. This can disrupt ongoing data protection operations. The error handling mechanisms of the applications may not be sufficiently robust to efficiently manage situations where a server fails to respond within a predefined maximum time because the server is offline for an upgrade. This can lead to problems with data corruption, files left in inconsistent states, and other issues when a data protection workload between the client application and server is being processed.

Therefore, there is a need for improved systems and techniques to conduct upgrades.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY

Forechannel connections are established from client-side deduplication libraries to a namespace node of a set of namespace nodes formed as a cluster. The namespace nodes are responsible for namespace operations on files managed by a deduplication filesystem. The forechannel connections are responsible for carrying file data between the client-side deduplication libraries and the namespace node. Server-initiated connections are established from the namespace node to the client-side deduplication libraries. The server-initiated connections are responsible for carrying instructions from the namespace node to the client-side deduplication libraries. While a transfer of file data is in progress, the client-side deduplication libraries are instructed over the server-initiated connections to failover the transfer to one or more other namespace nodes. After the failover, the namespace node is upgraded.

### BRIEF DESCRIPTION OF THE FIGURES

In the following drawings like reference numerals designate like structural elements. Although the figures depict various examples, the one or more embodiments and implementations described herein are not limited to the examples depicted in the figures.

FIG. 1 shows a block diagram of an information processing system having a clustered file system, according to one or more embodiments.

FIG. 2 shows an example of a deduplication process, according to one or more embodiments.

FIG. 3 shows an example of a namespace, according to one or more embodiments.

FIG. 4 shows an overall architecture of a clustered filesystem, according to one or more embodiments.

FIG. 5 shows an overall flow for handling upgrades of a clustered filesystem, according to one or more embodiments.

FIG. 6 shows an example of a clustered filesystem in a steady state, according to one or more embodiments.

FIG. 7 shows an example of the clustered filesystem when an upgrade is initiated by an upgrade service, according to one or more embodiments.

FIG. 8 shows an example of the clustered filesystem where a server has been notified of the upgrade, according to one or more embodiments.

FIG. 9 shows an example of the server in the clustered filesystem notifying connected clients of the upgrade, according to one or more embodiments.

FIG. 10 shows an example of the clients failing over to another server in the clustered filesystem, according to one or more embodiments.

FIG. 11 shows an example of failback messages being sent to the clients of the clustered filesystem, according to one or more embodiments.

FIG. 12 shows an example of a single-node filesystem in a steady state, according to one or more embodiments.

FIG. 13 shows an overall flow for conducting an upgrade of a single-node filesystem, according to one or more embodiments.

FIG. 14 shows an example of an upgrade being triggered in the single-node filesystem, according to one or more embodiments.

FIG. 15 shows an example of a server in the single-node filesystem notifying clients of the upgrade, according to one or more embodiments.

FIG. 16 shows an example of the clients in the single-node filesystem preparing for the upgrade, according to one or more embodiments.

FIG. 17 shows an example of data in the single-node filesystem being flushed to disk in preparation of the upgrade, according to one or more embodiments.

FIG. 18 shows an example of an in-progress upgrade of the single-node filesystem, according to one or more embodiments.

FIG. 19 shows an example of the clients polling the server of the single-node filesystem to attempt a reestablishment of connections, according to one or more embodiments.

FIG. 20 shows an example of the clients reestablishing connections to the server of the single-node filesystem, according to one or more embodiments.

FIG. 21 shows an example of file ingest continuing after the upgrade of the server in the single-node filesystem, according to one or more embodiments.

FIG. 22 shows a layer diagram of a server-initiated communication workflow, according to one or more embodiments.

FIG. 23 shows a block diagram of a server-initiated communication connection at a server-side, according to one or more embodiments.

FIG. 24 shows a block diagram of a server-initiated communication connection at a client-side, according to one or more embodiments.

FIG. 25 shows a sequence diagram of a server-initiated communication connection, according to one or more embodiments.

FIG. 26 shows a block diagram of a processing platform that may be utilized to implement at least a portion of an information processing system, according to one or more embodiments.

FIG. 27 shows a block diagram of a computer system suitable for use with the system, according to one or more embodiments.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the described embodiments. In this specification, these implementations, or any other form that the invention may take, may be referred to as techniques. In general, the order of the steps of disclosed processes may be altered within the scope of the invention. Aspects of the one or more embodiments described herein may be implemented on one or more computers executing software instructions, and the computers may be networked in a client-server arrangement or similar distributed computer network. In this disclosure, the variable N and other similar index variables are assumed to be arbitrary positive integers greater than or equal to two.

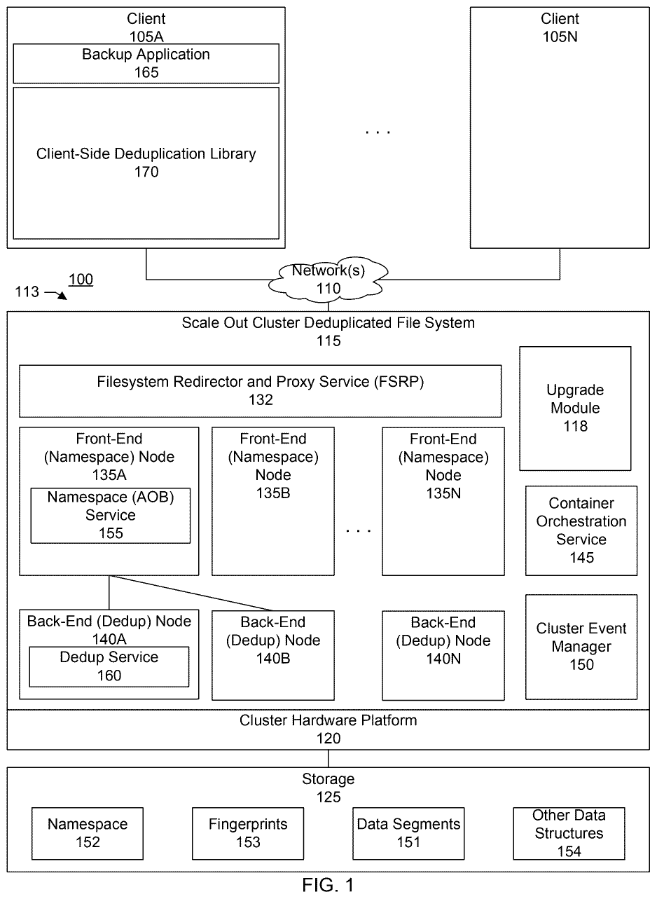

FIG. 1 shows a simplified block diagram of an information processing system 100 within which methods and systems for performing a seamless upgrade of a filesystem may be implemented. The example shown in FIG. 1 includes a set of clients 105A-N connected via a network 110 to a data protection appliance 113. The data protection appliance includes a deduplication filesystem 115 and an upgrade module 118. The upgrade module is responsible for minimizing or reducing disruption when a server, node, component, module, or service of the filesystem is to be upgraded. Such an upgrade may be referred to as a Non-Disruptive Upgrade (NDU).

The filesystem is hosted by an underlying hardware platform 120 which, in turn, is connected to a storage system 125. In an embodiment, the data protection appliance is a single-node appliance. That is, the filesystem runs on a single node (e.g., computer or server).

In another embodiment, the filesystem is a clustered or distributed filesystem such as shown in the example of FIG. 1. That is, the filesystem runs or is hosted across multiple (e.g., two or more) nodes connected to each other such as via a network or other connection scheme. In this embodiment, the data protection appliance may be referred to as a scale out appliance, scale out cluster, or scale out filesystem. Depending on demand, cluster nodes or services may be dynamically scaled up or down. For example, as part of on-going operations to meet changes in demand, new nodes or new instances of a service may be added to the cluster or existing nodes or instances of a service may be removed from the cluster.

This filesystem includes a filesystem redirector and proxy service (FSRP) 132, a set of front-end nodes or services 135A-N, a set of back-end nodes or services 140A-N, a container orchestration service 145, and a cluster event manager 150.

The file system provides a way to organize data stored in a storage system and present that data to clients and applications in a logical format. The file system organizes the data into files and folders into which the files may be stored. When a client requests access to a file, the file system issues a file handle or other identifier for the file to the client. The client can use the file handle or other identifier in subsequent operations involving the file. A namespace of the file system provides a hierarchical organizational structure for identifying file system objects through a file path. A file can be identified by its path through a structure of folders and subfolders in the file system. A file system may hold many hundreds of thousands or even many millions of files across many different folders and subfolders and spanning thousands of terabytes.

In an embodiment, the front-end nodes host front-end services 155. These front-end services may be referred to as access object (AOB) services and are responsible handling namespace operations and file access requests including file and folder creation and deletion, and random input/output (IO) reads and writes. As such, the front-end nodes may be referred to as namespace nodes or access object nodes. In an embodiment, namespace nodes are cluster nodes or a microservice that collectively hosts a cluster wide namespace. A namespace service refers to a service responsible for managing namespace across the cluster.

The back-end nodes host back-end services for handling compression and deduplication 160. As such, the back-end nodes may be referred to as deduplication or dedup nodes. In an embodiment, dedup nodes are cluster nodes or a microservice that collectively hosts the backup data. A node of a cluster may be a container, server, or virtual server.

The filesystem redirector and proxy service provides an entry point for a data path of the appliance. In an embodiment, initial connection requests by clients to the data protection appliance are handled by the filesystem redirector and proxy service. The filesystem redirector and proxy service determines which namespace node or AOB node should handle the request and then redirects the request to the appropriate namespace or AOB node. In an embodiment, the determination is based on a load-balancing algorithm that attempts to distribute incoming traffic evenly across the multiple namespace or AOB nodes. FSRP also attempts to route an incoming workload protection request of a given file or directory to the same or consistent node or AOB service. File data, metadata, or both may be cached in the node or AoB service. Hence routing the request to the same node or AOB service that previously worked on the file helps to reduce cache invalidations. Namespace data is also cached as pages in the node or AOB service. So routing the request to the same node or AOB service allows for reducing namespace page invalidations.

More particularly, in an embodiment, the client-side library receives an Internet Protocol (IP) address of the namespace or AOB node identified by FSRP as part of the redirection and issues a remote procedure call (RPC) for the file system operation request to the identified front-end or AOB node. In an embodiment, any AoB can handle namespace operations and file access, but different AoBs may be assigned responsibility for different ranges of files. Based on a hash of a file handle, path, or other information associated with a file, the filesystem redirector and proxy service attempts to redirect or route associated data protection traffic to a particular access object service in a consistent manner so that future writes and/or reads of the same file are routed consistently to the same access object service. Consistent routing or redirection by FSRP enables the AoBs to cache state in memory that may be reused for other accesses. Consistent routing further helps to reduce locking, coordination, and collision issues among different AoBs because each AoB can operate on its assigned range of files independent of another AoB that may be assigned a different range of files. An AoB attempts to keep necessary state in memory for efficiency. The state, however, is globally available and can be handled by other AoB instances in case of an instance failure or other unavailability. The files or, more particularly, file handle hash ranges can be dynamically reassigned to the AoBs to maintain a balance across currently available AoBs. A more detailed description of FSRP is provided in U.S. patent application Ser. No. 18/428,717, filed, Jan. 31, 2024, which is incorporated by reference along with all other references cited.

In an embodiment, the file system is implemented as a set of microservices (e.g., front-end microservices and back-end microservices) running as containers. The file system uses the underlying storage system for persistence. The container orchestration service is responsible for managing the microservices such as adding a new instance of a front-end service, back-end service, or both to accommodate an increase in demand and thus ensure good performance for clients that may be accessing the file system and requesting file system operations. Alternatively, the orchestration service may remove an existing instance of a front-end service, back-end service, or both to accommodate a decrease in demand and thus reduce costs associated with resources needed to run the services. The number of instances of each microservice can change based on demand. An example of a container orchestration service is Kubernetes. Kubernetes is an open-source container-orchestration system for automating computer application deployment, scaling, and management.

A container is a virtualized computing environment to run an application program as a service or, more specifically, microservice. Thus, in an embodiment, the file system microservices, including namespace and deduplication services, run inside a virtualized environment provided by the orchestration service. The container orchestration layer can run on a single or multiple physical or virtual nodes. Containers are similar to virtual machines (VMs). Unlike VMs, however, containers have relaxed isolation properties to share the operating system (OS) among the containerized application programs. Containers are thus considered lightweight. Containers can be portable across hardware platforms including clouds because they are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

The cluster event manager communicates with the orchestration service for cluster updates and is a service that is responsible for sending events about changes in the cluster such as node addition/deletion or service addition/deletion. In an embodiment, these events detail changes to the cluster and are sent from the cluster event manager to FSRP or the front-end or namespace nodes which, in turn, forward the cluster change events to the clients.

Installed at each client is a client application such as a backup application 165 and client-side deduplication library 170. In an embodiment, the clients may be referred to as backup clients. The file system provides a backup target for data generated by the clients. In an embodiment, when the backup application seeks to perform a file system operation, the backup application issues a call (e.g., application programming interface (API) call) to the client-side deduplication library to request the file system operation. The client-side deduplication library processes and forwards the request to the data protection appliance for fulfillment. The results of the request are returned by the data protection appliance to the client-side library which, in turn, passes the results back to the requesting client application. An example of a client-side deduplication library is Data Domain Boost (DDBoost) as provided by Dell Technologies of Round Rock, Texas. Some embodiments are described in conjunction with the DDBoost protocol, Data Domain Restorer (DDR) storage system, and Data Domain file system as provided by Dell Technologies. It should be appreciated, however, that principles and aspects discussed can be applied to other file systems, file system protocols, and backup storage systems.

In an embodiment, the clients access the file system using a protocol referred to as DDBoost. Thus, the clients may be referred to as DDBoost clients. The clients (e.g., DDBoost clients) connect to the namespace nodes to perform file operations for backup jobs, restore jobs, or other data protection operations. DDBoost is a system that distributes parts of a deduplication process to the application clients, enabling client-side deduplication for faster, more efficient backup and recovery. In an embodiment, the clients use the DDBoost backup protocol to conduct backups of client data to the storage system, restore the backups from the storage system to the clients, or perform other data protection operations. The DDBoost library exposes application programming interfaces (APIs) to integrate with a Data Domain system using an optimized transport mechanism. These API interfaces exported by the DDBoost library provide mechanisms to access or manipulate the functionality of a Data Domain file system. Embodiments may utilize the DDBoost File System Plug-In (BoostFS), which resides on the application system and presents a standard file system mount point to the application. With direct access to a BoostFS mount point, the application can leverage the storage and network efficiencies of the DDBoost protocol for backup and recovery. A client may run any number of different types of protocols as the file system supports multiple network protocols for accessing remote centrally stored data (e.g., Network File System (NFS), Common Internet File System (CIFS), Server Message Block (SMB), and others).

The clients may include servers, desktop computers, laptops, tablets, smartphones, internet of things (IoT) devices, or combinations of these. The network may be a cloud network, local area network (LAN), wide area network (WAN) or other appropriate network. The network provides connectivity to the various systems, components, and resources of the system, and may be implemented using protocols such as Transmission Control Protocol (TCP) and/or Internet Protocol (IP), well-known in the relevant arts. In a distributed network environment, the network may represent a cloud-based network environment in which applications, servers and data are maintained and provided through a centralized cloud computing platform. In an embodiment, the system may represent a multi-tenant network in which a server computer runs a single instance of a program serving multiple clients (tenants) in which the program is designed to virtually partition its data so that each client works with its own customized virtual application, with each virtual machine (VM) representing virtual clients that may be supported by one or more servers within each VM, or other type of centralized network server.

The storage includes, in addition to user data segments 151, other data structures storing metadata to facilitate access to the data via file system protocols, scaling of the file system, and deduplication. In particular, storage includes a namespace 152 and fingerprints 153, among other data structures 154. In an embodiment, the namespace is held in a tree structure and, more specifically, a Btree. The fingerprints correspond to unique hash values calculated from the data segments and may be stored in a fingerprint index. Further discussion is provided below.

The storage system may include storage servers, clusters of storage servers, network storage device, storage device arrays, storage subsystems including RAID (Redundant Array of Independent Disks) components, a storage area network (SAN), Network-attached Storage (NAS), or Direct-attached Storage (DAS) that make use of large-scale network accessible storage devices, such as large capacity tape or drive (optical or magnetic) arrays, shared storage pool, or an object or cloud storage service. In an embodiment, storage (e.g., tape or disk array) may represent any practical storage device or set of devices, such as tape libraries, virtual tape libraries (VTL), fiber-channel (FC) storage area network devices, and OST (OpenStorage) devices. The storage may include any number of storage arrays having any number of disk arrays organized into logical unit numbers (LUNs). A LUN is a number or other identifier used to identify a logical storage unit. A disk may be configured as a single LUN or may include multiple disks. A LUN may include a portion of a disk, portions of multiple disks, or multiple complete disks. Thus, storage may represent logical storage that includes any number of physical storage devices connected to form a logical storage.

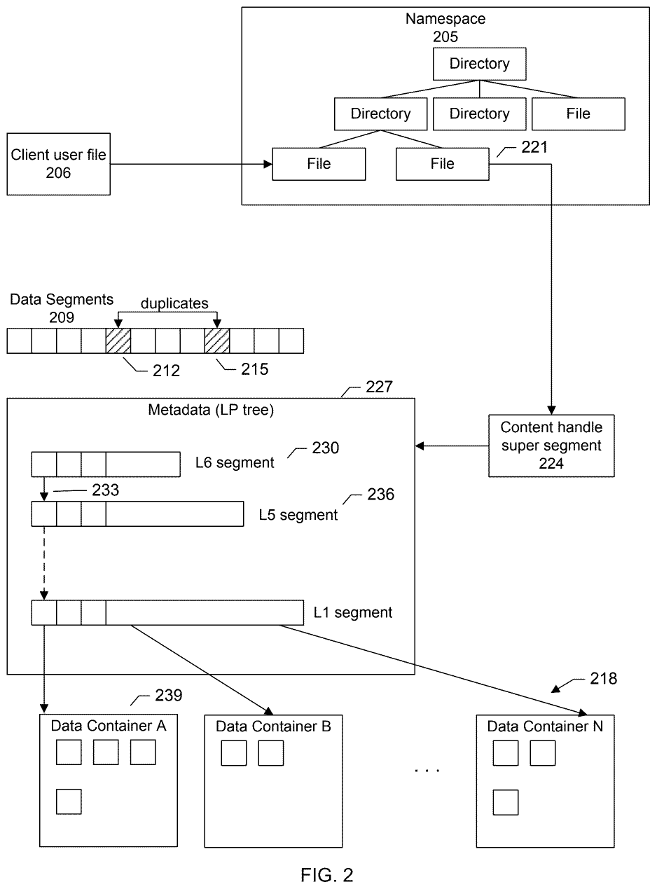

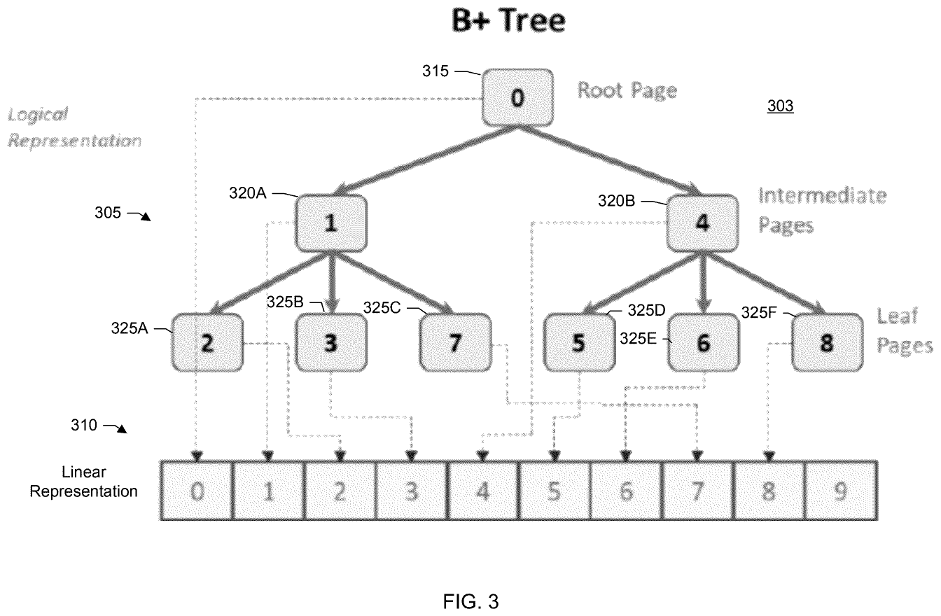

FIG. 2 shows a block diagram illustrating a deduplication process of the filesystem according to one or more embodiments. A deduplicated filesystem is a type of filesystem that can reduce the amount of redundant data that is stored. As shown in the example of FIG. 2, the filesystem maintains a namespace 205. Further details of a filesystem namespace are provided in FIG. 3 and the discussion accompanying FIG. 3.

The process of backing up a file to the filesystem may be referred to as ingest. More particularly, as data, such as incoming client user file 206, enters the filesystem, it is segmented into data segments 209 and filtered against existing segments to remove duplicates (e.g., duplicate segments 212, 215). A segment that happens to be the same as another segment that is already stored in the filesystem may not be again stored. This helps to eliminate redundant data and conserve storage space. Metadata, however, is generated and stored that allows the filesystem to reconstruct or reassemble the file using the already or previously stored segment. Metadata is different from user data. Metadata may be used to track in the filesystem the location of the user data within a shared storage pool. The amount of metadata may range from about 2 or 4 percent the size of the user data.

More specifically, the filesystem maintains among other metadata structures a fingerprint index. The fingerprint index includes a listing of fingerprints corresponding to data segments already stored to the storage pool. A cryptographic hash function (e.g., Secure Hash Algorithm 1 (SHA1)) is applied to segments of the incoming file to calculate the fingerprints (e.g., SHA1 hash values) for each of the data segments making up the incoming file. The fingerprints are compared to the existing fingerprints in the fingerprint index. Matching fingerprints indicate that corresponding data segments are already stored. Non-matching fingerprints indicate that the corresponding data segments are unique and should be stored.

Unique data segments are packed and stored in fixed size immutable containers 218. There can be many millions of containers tracked by the filesystem. The fingerprint index is updated with the fingerprints corresponding to the newly stored data segments. A content handle 221 of the file is kept in the filesystem's namespace to support the directory hierarchy. The content handle points to a super segment 224 which holds a reference to a top of a segment tree 227 of the file. The super segment points to a top reference 230 that points 233 to metadata 236 and data segments 239.

Thus, in a specific embodiment, each file in the filesystem may be represented by a tree. The tree includes a set of segment levels arranged into a hierarchy (e.g., parent-child). Each upper level of the tree includes one or more pointers or references to a lower level of the tree. A last upper level of the tree points to the actual data segments. Thus, upper level segments store metadata while the lowest level segments are the actual data segments. In an embodiment, a segment in an upper level includes a fingerprint (e.g., metadata) of fingerprints of one or more segments in a next lower level (e.g., child level) that the upper level segment references.

A tree may have any number of levels. The number of levels may depend on factors such as the expected size of files that are to be stored, desired deduplication ratio, available resources, overhead, and so forth. In a specific embodiment, there are seven levels L6 to L0. L6 refers to the top level. L6 may be referred to as a root level. L0 refers to the lowest level. Thus, the upper segment levels (from L6 to L1) are the metadata segments and may be referred to as LPs. That is, the L6 to L1 segments include metadata of their respective child segments. The lowest level segments are the data segments and may be referred to as L0s or leaf nodes. In an embodiment, segments in the filesystem are identified by 24 byte keys (or the fingerprint of a segment), including the LP segments. Each LP segment contains references to lower level LP segments.

FIG. 3 shows further detail of a namespace of the filesystem. In an embodiment, the namespace is represented by a B+ tree data structure where pages of the tree are written to a key-value store. Page identifiers form the keys of the key-value store and page content form the values of the key-value store. The tree data structure includes the folder and file structure as well as file inodes. FIG. 3 shows an example of a B+ Tree 303 in a logical representation 305 and a linear representation 310. In this example, there is a root page 315, intermediate pages 320A,B, and leaf pages 325A-F. The broken lines shown in FIG. 3 map the pages from their logical representation in the tree to their representation as a linear sequential set of pages on disk, e.g., flattened on-disk layout. In other words, the tree may be represented as a line of pages of data.

The intermediate pages store lookup keys that reference other intermediate or leaf pages. An intermediate page may be referred to as an INT page and references other INT pages or leaf pages by interior keys.

The leaf page contains “key/value” pairs. In an embodiment, a B+ Tree key is a 128-bit number kept in sorted order on the page. It is accompanied by a “value,” which is an index to data associated with that key and may be referred to as a “payload.” In an embodiment, the 128-bit key includes a 64-bit PID, or parent file ID (the ID of the directory that owns this item), and a 64-bit CID, or child file ID. In an embodiment, the leaf page stores a key for each file in the filesystem. The key references a payload identifying an inode number of the file and thus a pointer to content or data of the file. There can be another key for each file that identifies a name of the file.

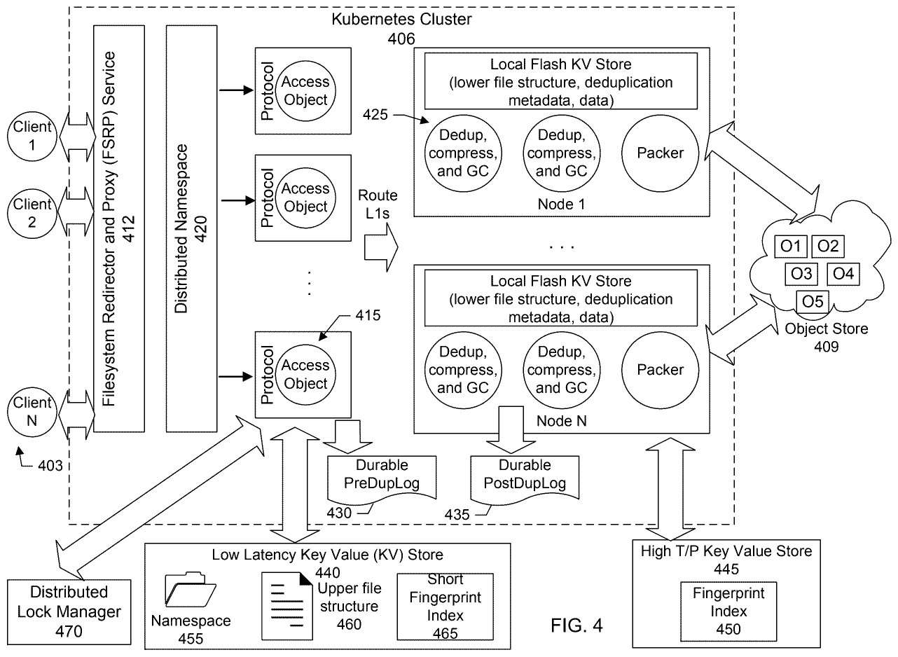

FIG. 4 shows an example of an architecture of the scale-out data protection appliance, according to one or more embodiments. The example shown in FIG. 4 includes a set of clients 403, a cluster 406 at which a deduplicated filesystem is hosted across nodes of the cluster, and an object store 409 storing file data segments that have been packed into objects. As discussed, in an embodiment, the cluster is a Kubernetes cluster where the filesystem is provided as a set of microservices. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and a Docker program can deploy containers as portable, self-sufficient structures that can run on everything from physical computers to VMs, bare-metal servers, cloud clusters, and so forth. The Kubernetes system manages containerized applications in a clustered environment to help manage related, distributed components across varied infrastructures. Certain applications, such as multi-tenant shared databases running in a Kubernetes cluster, spread data over many volumes that are accessed by multiple cluster nodes in parallel.

The cluster includes FSRP 412 and a set of nodes hosting a set of AOBs 415 across which a namespace 420 is distributed. Data is spread across multiple storage devices as may be provided in a cluster of nodes.

Nodes perform tasks that are controlled and scheduled by software. The nodes and other components of the system may communicate with each other over the network via messages and based on the message content, they perform certain acts such as reading data from the disk into memory, writing data stored in memory to the disk, performing computation (CPU), sending another network message to the same or a different set of components, and so forth. These acts, also called component actions, when executed in time order (by the associated component) in a distributed system would constitute a distributed operation. The scale out appliance may include any practical number of nodes. Nodes may include installed agents, services, or other resources to process the data.

The filesystem is shared by being simultaneously mounted on multiple servers. The file system can present a global namespace to clients or node sin a cluster accessing the data so that files appear to be in the same central location. In an embodiment, the file system stores the file system metadata on a distributed key value store and the file data on object store. The file/namespace metadata can be accessed by any AOB node, and any file can be opened for read/write by any AOB node. As discussed, in an embodiment, distributed key value stores are used to hold much of the metadata such as the namespace Btree, the Lp tree, fingerprint index, and container fingerprints. These run as containers within the cluster and may be stored to low latency media such as NVMe. There can also be a distributed and durable log that replaces NVRAM.

In particular, AOBs may handle namespace operations, file access requests, file creation, folder creation, file reads, and file writes. AOBs are responsible for operations involving upper levels of the tree data structures representing the files.

There is another set of nodes hosting other services 425 that handle lower levels of the tree or file structures, such as the L1-L0 segments. Such services may include services for deduplication, compression, garbage collection, and packing of file segments into objects for storage in the object store. The AOBs route the lower level segments including L1s to these other backend services for further processing, e.g., deduplication, compression, and packing.

Operations and activities of the services may be recorded in a log. There can be a durable pre-deduplication log 430 used by the AOBs and a durable post-deduplication log 435 used by the backend services. The logs can be used to allow operations to resume following an interruption of a particular service instance.

A key value store may be used to store metadata of the filesystem. There can be a low latency key value store 440 used by the AOBs and a high throughput key value store 445 used by the backend deduplication, compression, garbage collection, and packing services. The high throughput key value store stores a fingerprint index 450. The low latency key value store stores a namespace 455, upper file structure (e.g., upper segment tree levels) 460, and a short fingerprint index 465.

There can be a distributed lock manager 470 to coordinate file and folder updates by the AOBs to the Btree structure holding the namespace. When an AOB needs to make an update, the AOB acquires from the distributed lock manager a lock on one or more pages of the tree structure and makes the updates.

The filesystem supports multiple network protocols for accessing the data stored and managed by the filesystem. Such protocols include Data Domain Boost (“Boost” or “DDBoost”), Network Filesystem (NFS), and Amazon Simple Storage Service (S3), among others. DDBoost is a system that distributes parts of a deduplication process to the application clients, enabling client-side deduplication for faster, more efficient backup and recovery.

In an embodiment, the data protection system is built on a Kubernetes PaaS (Platform as a Service). The filesystem redirection proxy (FSRP) is a service which is the entry point for a data-path. At the start of backup/restore operations, the clients (e.g., Boost clients) talk with the FSRP service to obtain an Internet protocol (IP) address identifying an access object service to handle the requested operation. FSRP returns an IP address of a particular access object service to the requesting client. The client can then connect directly to the particular access object service to complete the processing of their requested operation.

Upgrades, whether they are in a single-node appliance or scale-out appliance, can be disruptive and impact performance. For example, upgrades in a single-node may necessitate a halt to backups and cause downtime. In a clustered implementation which is scalable and designed to support a variable number of nodes, e.g., ranging from 16 to 1024, there remains a need to have improved systems and techniques for non-disruptive upgrades. Relying on error handling and timeouts for failover to other nodes in the cluster can be problematic. Consider, as an example, a connection timeout of 5 minutes. This means a client (e.g., DDBoost client) polls for this duration to detect an AoB being upgraded. This is not efficient. Moreover, because of the interruption, the DDBoost client will need to replay its high availability (HA) buffer from a last synced buffer for on-going writes to the backup files. This requirement exists because the Boost client cannot distinguish between upgrades and filesystem panics on the AoB side.

In an embodiment, systems and techniques provide for seamless upgrades in a multi-node clustered filesystem and also non-disruptive upgrades in a single-node appliance. In an embodiment, a failover and failback mechanism operates seamlessly without affecting input/output (I/O) performance. Also, DDBoost performs inline deduplication and hence client and server needs to maintain consistent state while processing RPCs during exchanging segment information, the disclosed systems and techniques help to ensure that it works correctly.

In an embodiment, systems and techniques use server-initiated connections to transmit failover and failback messages to the client (e.g., DDBoost client). A failover message may be sent from an AoB while a failback message may be sent from the FSRP to avoid a DDBoost client polling to an AoB until the upgrade is finished. Systems and techniques further provide for DDBoost clients to seamlessly fail over connections from one AoB to another and revert them post-upgrade. Also, failing over connections are distributed among all running AoBs. In an embodiment, systems and techniques provide for pausing and resuming IOs in the DDBoost client. This can be particularly beneficial for scenarios where failover is not feasible, such as in a single-node appliance.

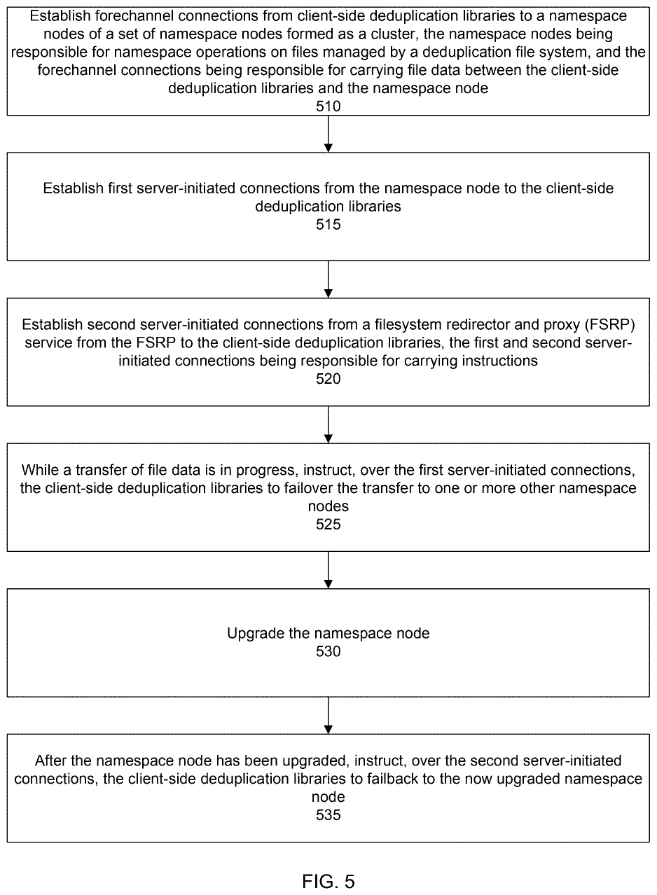

FIG. 5 shows an overall flow for conducting an upgrade of a clustered filesystem. Some specific flows are presented in this application, but it should be understood that the process is not limited to the specific flows and steps presented. For example, a flow may have additional steps (not necessarily described in this application), different steps which replace some of the steps presented, fewer steps or a subset of the steps presented, or steps in a different order than presented, or any combination of these. Further, the steps in other embodiments may not be exactly the same as the steps presented and may be modified or altered as appropriate for a particular process, application or based on the data.

In brief, in a step 510, forechannel connections are established from client-side deduplication libraries at clients to a namespace node belonging to a set of namespace nodes formed into a cluster. The namespace nodes are responsible for namespace operations on files managed by a deduplication filesystem. The forechannel connections are responsible for carrying file data between the client-side deduplication libraries and the namespace node.

In a step 515, first server-initiated connections are established from the namespace node to the client-side deduplication libraries. In a step 520, second server-initiated connections are established from a filesystem redirector and proxy (FSRP) service to the client-side deduplication libraries. The first and second server-initiated connection are responsible for carrying instructions to the client-side deduplication libraries. The first server-initiated connection carries instructions from the namespace node to the client-side deduplication libraries. The second server-initiated connection carries instructions from the FSRP service to the client-side deduplication libraries.

In a step 525, while a transfer of file data is in progress, the client-side deduplication libraries are instructed by the namespace node and over the first server-initiated connections to failover the transfer of the file data to one or more other namespace nodes of the cluster.

In a step 530, the namespace node is upgraded.

In a step 535, after the namespace node has been upgraded, the client-side deduplication libraries are instructed by the FSRP service and over the second server-initiated connections to failback to the now upgraded namespace node.

A design of the system allows the upgrade of the filesystem server or node to be transparent to the client application, e.g., client backup application. That is, the client application can continue sending requests to the client-side deduplication library throughout the upgrade process and then continue uninterrupted after the upgrade has completed. Specifically, as discussed, in an embodiment, the client-side deduplication library at the client provides an interface for handling requests from a client backup application at the client for files managed by the remote data protection appliance and filesystem. Backing up files to appliance and accessing the files involves generating connection and file descriptors to represent and identify the network connections and files.

Connection descriptors representing network connections between the client and the filesystem may be exposed to, presented to, or used by the backup application. The connection descriptors may indicate or maintain state information about the network connection such as server address and port, authentication credentials, security parameters, protocol, host, service, other connection related information, or combinations of these.

File descriptors representing IO streams or the files that are open with the filesystem may likewise be exposed to, presented to, or used by the backup application. The file descriptors may be used by the client backup application to perform read, write, and other file operations. The file descriptors can allow the files to appear local to the application. Multiple file descriptors may be associated with a single connection descriptor. A file descriptor may include detail or file metadata such as access mode (e.g., read, write), file size, permissions, ownership information, timestamps (e.g., access, modification, creation), inode information, other file detail, or combinations of these.

During the upgrade of the server, the open connections to the server and the files opened with the server may be closed. However, the connection and file descriptors previously exposed to and being used by the backup application before the upgrade are marked or flagged by the client-side deduplication library to indicate that an upgrade is in progress and that the connection and file descriptors should not be invalidated or reused. A mapping is maintained, by the client-side deduplication library, of the files and the associated connection and file descriptors. After the upgrade of the server is completed, connections to the now upgraded server are reopened along with reopening the closed files. The mapping may be used to re-associate the same connection and file descriptors exposed to the backup application before the upgrade with the corresponding reopened connections and files. This allows the operations of the backup application to continue uninterrupted after the upgrade with the same connection and file descriptors the backup application was using before the upgrade.

In an embodiment, a method may include: receiving, at a client-side deduplication library at a client, a message indicating that a server of a filesystem is to be upgraded, the client-side deduplication library handling requests from a backup application at the client for files managed by the filesystem, and the files being associated with connection descriptors and file descriptors exposed to the backup application to access the files; closing the files and connections to the server associated with the files; after the closing, starting the upgrade of the server; while the upgrade of the server is in progress, marking the connection descriptors and the file descriptors with a flag to indicate that an upgrade of the server is in progress, the flag thereby preventing the connection descriptors and the file descriptors from being reused; maintaining a mapping of the files to the connection descriptors and the file descriptors; and allowing the backup application to continue sending the requests to the client-side deduplication library; upon completion of the upgrade, re-establishing the connections to the server and associating the reestablished connections with the connection descriptors exposed to the backup application before the upgrade according to the mapping; and re-opening the files and associating the re-opened files with the file descriptors exposed to the backup application before the upgrade according to the mapping.

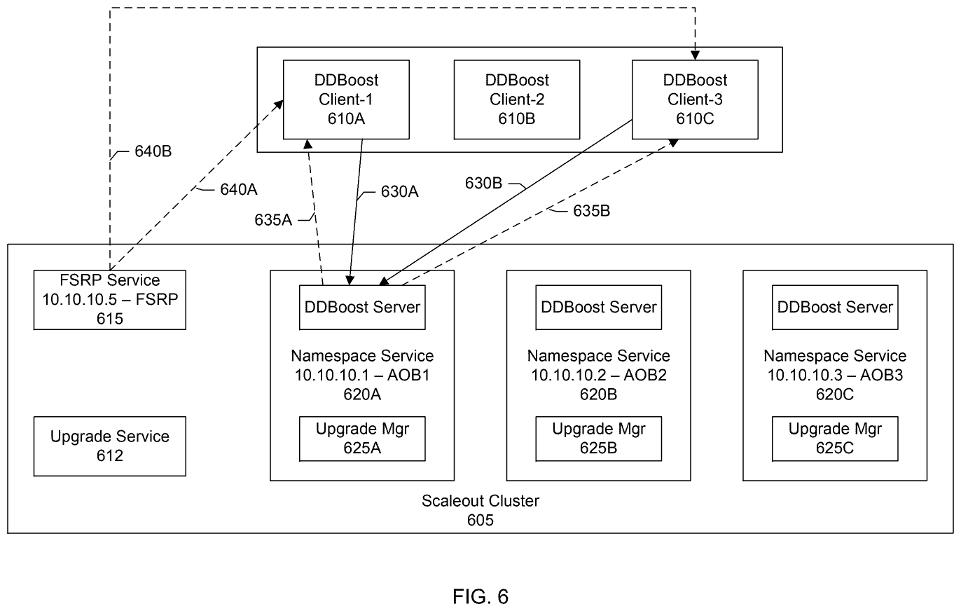

FIG. 6 shows a block diagram of a clustered filesystem within which a node of a cluster may be upgraded. In the example shown in FIG. 6, there is a scale out cluster 605 hosting a filesystem that manages files for a set of clients having client-side deduplication libraries 610A-C, e.g., DDBoost. As discussed, DDBoost includes a proprietary protocol that is used to extend part of the DataDomain optimized file transfer operations to a library on the backup client system. DDBoost clients may thus refer to backup systems using the DDBoost software development kit (SDK) client library to connect with the Data Domain Restorer (DDR) or scale-out namespace nodes to perform optimized file operations (e.g., backup, restore, replication, and so forth).

The cluster includes an upgrade service 612 and a set of components accessible by IP addresses such as a filesystem redirector and proxy service 615 and first, second, and third access object (AOB) nodes 620A-C. The filesystem redirector and proxy service redirects DDBoost clients to AoBs based on file hashing.

The nodes host services such as a namespace service and server (e.g., DDBoost server). Nodes 620A-C further include upgrade managers 625A-C, respectively. The upgrade service resides outside the nodes and coordinates with the upgrade managers residing at the nodes to manage the upgrade process.

The example shown in FIG. 6 shows a steady state where forechannel connections 630A,B, first server-initiated connections 635A,B, and second server-initiated connections 640A,B have been established. The forechannel connections are shown using arrows with solid lines. The server-initiated connections are shown using arrows with broken lines. Specifically, forechannel connection 630A is from first client-side deduplication library 610A to first node 620A. Forechannel connection 630B is from third client-side deduplication library 610C to first node 620A. Server-initiated connection 635A is from AOB node 620A to client library 610A. Server-initiated connection 635B is from AOB node 620A to client library 610C. Server-initiated connection 640A is from FSRP to client library 610A. Server-initiated connection 640B is from FSRP to client library 610C. In an embodiment, a DDBoost server-initiated is a mechanism by which DDR can communicate back RPC messages to a DDBoost client just like DDBoost communicates with DDR. The DDBoost server-initiated connection is established during the first or initial connection to the node.

The client libraries may be engaged with data protection IO operations with the cluster. For example, client library 610A may be backing up to the filesystem a first file that has been assigned to AOB node 620A. Client library 610C may be backing up to the filesystem a second file that has been assigned to AOB node 620A. File data associated with the files is transmitted over the forechannel connections. The server-initiated connections are established to carry instructions to the client libraries to facilitate an upgrade of a node of the cluster.

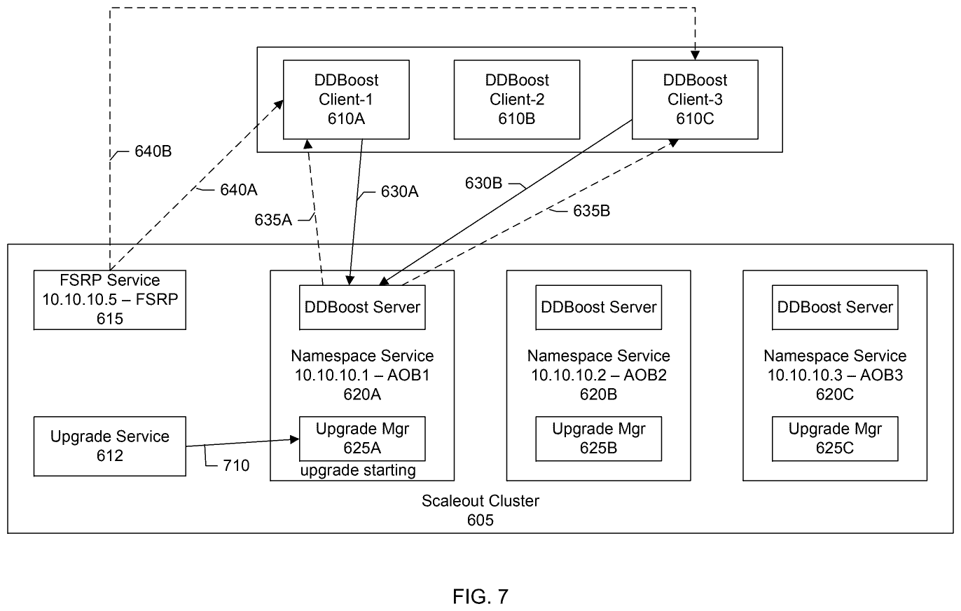

FIG. 7 shows a start of the upgrade process. When a node (e.g., AOB node 620A) is to be upgraded, the upgrade service issues a pre-stop message 710 to the upgrade manager of the node.

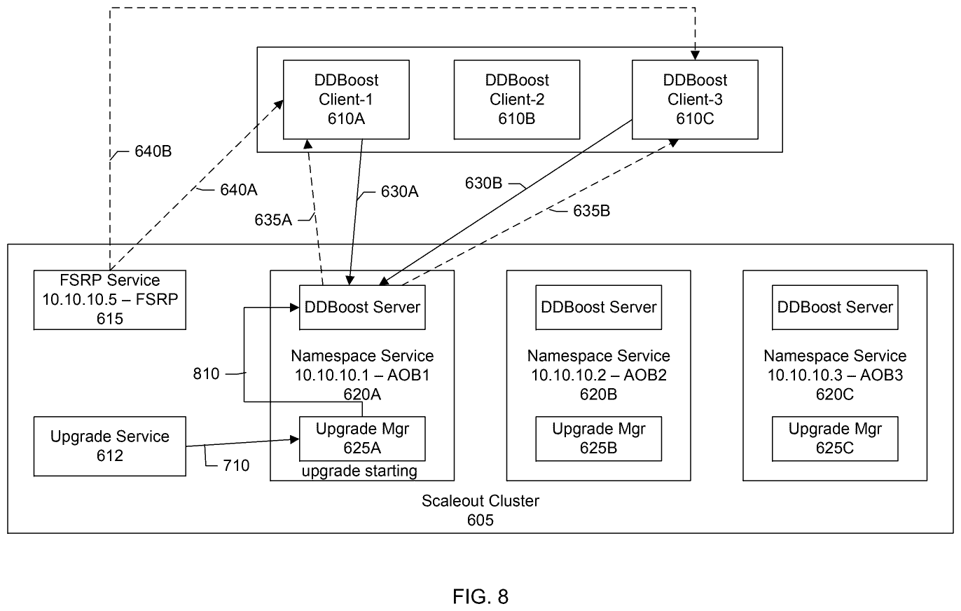

Referring now to FIG. 8, the upgrade manager, in turn, issues 810 a notification to the server (e.g., DDBoost server) to inform the server that an upgrade is starting.

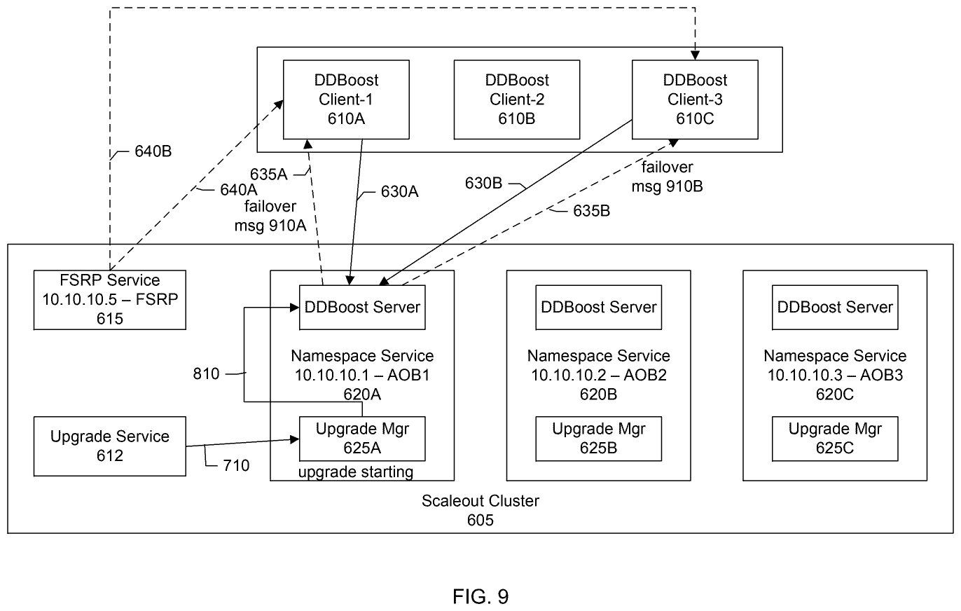

Referring now to FIG. 9, the server, in turn, issues, over server-initiated connections 635A,B failover messages 910A,B to the client libraries, respectively, that are connected to it for current data protection IO operations. These failover messages instruct the relevant client libraries that the node is about to go offline for an upgrade that that they should failover to one or more other nodes of the cluster while the upgrade is in progress.

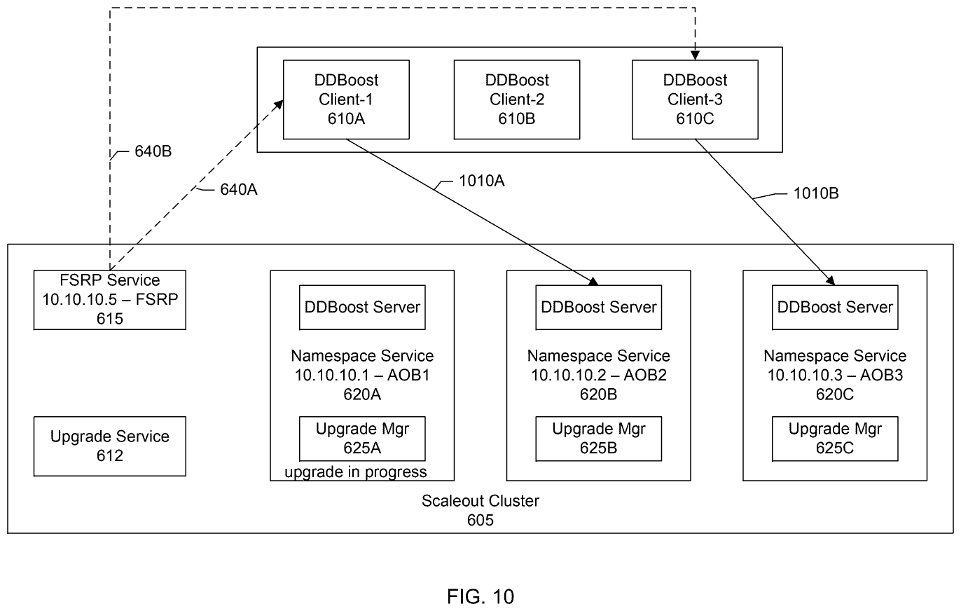

Referring now to FIG. 10, client library 610A has failed over 1010A to AOB node 620B. Client library 610C has failed over 1010B to AOB node 620C. The selection of the one or more nodes to failover to may be based on an evaluation of a load balancing algorithm. Any competent load balancing algorithm may be used. An example of a load balancing algorithm is a round-robin algorithm. In a round-robin algorithm, data protection operations or workloads are distributed sequentially in a circular order to other available nodes of the cluster. For example, a first data protection workload being handled by AOB node 620A for client library 610A may be distributed to AOB node 620B. A second data protection workload being handled by AOB node 620A for client library 610C may be distributed to AOB node 620C, and so forth.

Once the data protection workloads have been failed over, the node (e.g., AOB node 620A) is taken offline and upgraded. The failover messages transmitted before the closing of the connections, however, provides the relevant client libraries with advance notice of the upgrade and upcoming offline status to allow the client libraries to gracefully close any open files with the AOB node to be upgraded, flush and commit any data, and make other preparations for the upgrade. The client libraries will not have to rely on any error handling, timeout, or polling mechanism as may be the case when an AOB node becomes unavailable without warning.

The upgrade may cause a termination or closing of any connections to or from the node. For example, the omission of server-initiated connections 635A,B from FIG. 10 indicate the closing of the connections. Server-initiated connections 640A,B from FSRP to client libraries 610A,C, however, remain unaffected. This allows the FSRP to notify the client libraries of a completion of the upgrade so that the data protection workloads or operations can be failed back. The client libraries do not have to repeatedly poll or check whether the upgrade is complete because of server-initiated connections 640A,B are maintained throughout the upgrade.

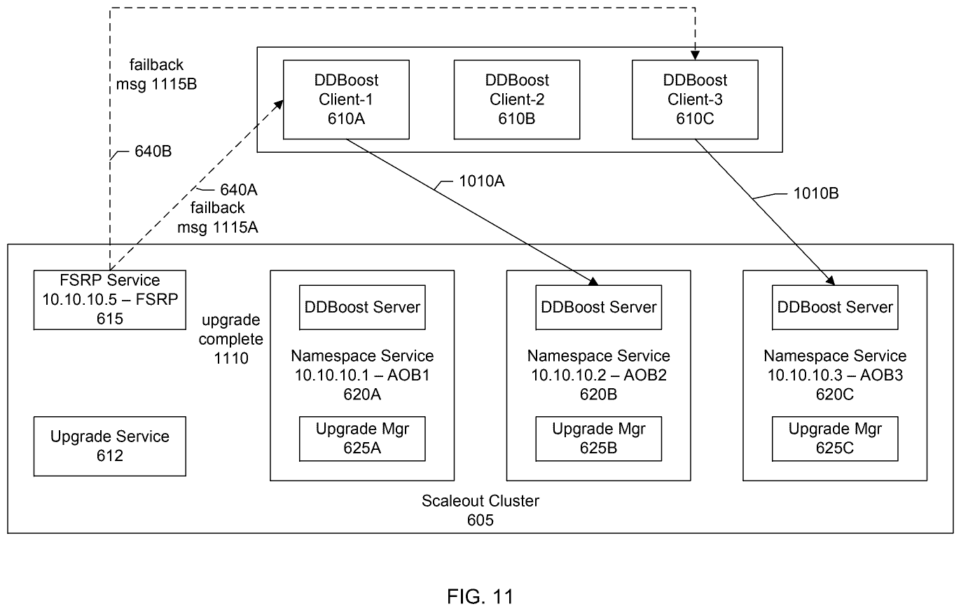

Specifically, FIG. 11 shows the upgrade of AOB node 620A having been completed 1110. Upon completion, FSRP uses server-initiated connections 640A,B to send failback messages 1115A,B to client libraries 610A,C, respectively. Upon receipt of the failback messages, client library 610A may failback from AOB node 620B to now upgraded AOB node 620A. Similarly, client library 610C may failback from AOB node 620C to now upgraded AOB node 620A.

Table A below shows further detail of a flow for conducting an upgrade of a clustered filesystem.

TABLE A

| Step | Description |
|---|---|
| 1 | DDBoost client establishes connections with AoB and performs ingest. |
| 2 | The service responsible for performing Non-Disruptive Upgrades within a cluster |
| | attempts to notify all other services by sending a pre-stop message or by invoking |
| | Kubernetes pre-stop hooks. |
| 3 | Each individual service handles Pre-Stop requests. An AoB or namespace service in this |
| | handling notifies DDBoost Server-initiated infrastructure about upgrades happening or |
| | occurring. |
| 4 | DDBoost Server-initiated Infra starts scheduling messages to all the DDBoost clients |
| | which are connected to the subject AoB, e.g., AOB1, and sends message to start failing |
| | over the connections gracefully. |
| 5 | DDBoost client upon receipt of the message performs the following: |
| 6A | Adds a barrier and stops doing any further IOs to AoB1. This can be done by marking |
| | node AOB1 under upgrade. |
| 6B | Stops creating new connections and stops creating new files on that AoB by marking that |
| | AoB as unavailable. |
| 6C | a) It iterates over each file descriptors for particular connection descriptors |
| | b) It closes the file and marks it as failed over. |
| | c) The close and commit operation triggers a flush of dirty and stale data on the |
| | namespace service (e.g., AoB1) and hence making all data stable on the key valu store |
| | (KVS) and object store (OBS) as well as giving up all distributed lock manager (DLM) |
| | locks owned by that node. |
| 6D | FIG. 10 shows Client1's connection-1 failed over to AoB-2 whereas Client-3's |
| | connection-1 failed over to AoB-3 |
| 7 | DDBoost server posts an async event in the server-initiated infrastructure to notify the |
| | upgrade manager about failover complete |
| 8 | Upgrade service is notified about Pre-Stop hook complete. At this point, AoB is |
| | upgraded with the new software. |
| 9 | Once the upgrade is over, AoB is started and boots up and registers with the cluster |
| | again. |
| 10 | This results in a cluster event being sent to all the other services. FSRP (Load Balancer) |
| | upon receipt of this event, it sends a FAILBACK message to all DDBoost clients |
| 11A | DDBoost client re-opens the file after re-establishing connection again with AoB1 |
| | (which is failover node in our example) |
| 11B | DDBoost client responds to the failback message immediately. |
| 12 | DDBoost client removes the barrier and starts doing IO and also new files can be opened |
| | on AoB1. |

In an embodiment, the client-side library (e.g., DDBoost client) makes sure that all the connection descriptor and file descriptor visible to the applications are not invalidated and the mapping is still the same for each file opened by application and hence this is completely transparent to backup application. Since failover and failback mechanism is done file by file, this takes no longer than simple sync/commit operation. Even errors during failback will not impact IO performance because the DDBoost client can still continue on failed over node as well. Upgrades of other services are transparent to DDBoost clients. Also, a clustered filesystem may deploy rolling upgrades and this technique can be used to upgrade each AOB one-by-one.

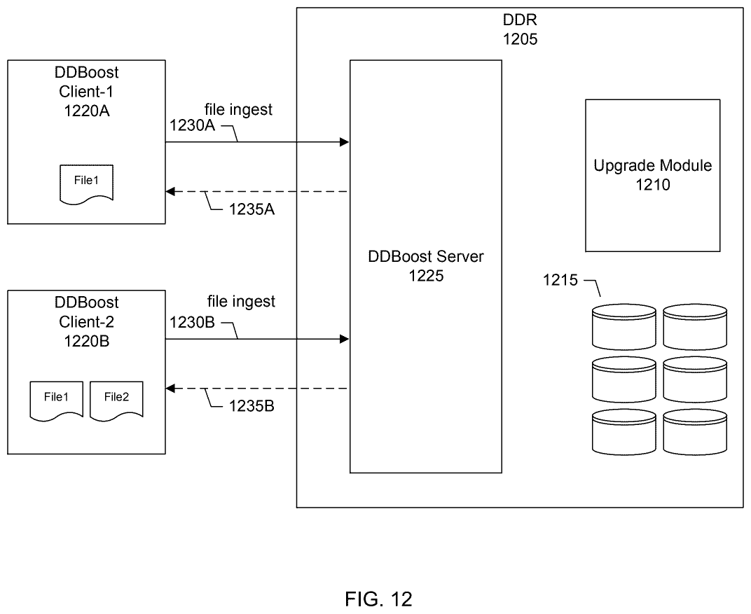

FIG. 12 shows a block diagram of a single node data protection appliance 1205. As discussed, in another embodiment, server-initiated messages can be implemented for a single-node appliance. The example shown in FIG. 12 is similar to the example shown in FIG. 6. For example, the data protection appliance may include an upgrade module 1210 and storage 1215 for files. Similarly, there can be clients having client-side deduplication libraries 1220A,B, e.g., DDBoost, that connect with the data protection appliance for file backup and other data protection operations. In the example shown in FIG. 12, however, the data protection appliance has a single node or single server (e.g., DDBoost server) 1225 hosting the deduplication filesystem. The upgrade module resides outside the server and is responsible for managing the upgrade of the server.

The example shown in FIG. 12 shows a steady state where forechannel connections 1230A,B and server-initiated connections 1235A,B have been established. The forechannel connections are shown using arrows with solid lines. The server-initiated connections are shown using arrows with broken lines. Specifically, forechannel connection 1230A is from first client-side deduplication library 1220A to server 1225. Forechannel connection 1230B is from second client-side deduplication library 1220B to server 1225. Server-initiated connection 1235A is from server 1225 to client library 1220A. Server-initiated connection 1235B is from server 1225 to client library 1220B. The client libraries are engaged with data protection IO operations with the server. For example, the clients may be in the process of backing up one or more files to the data protection appliance in a process referred to as file ingest.

The single node appliance lacks a secondary node to failover to. In an embodiment, the upgrade of a single node appliance is thus handled by pausing and resuming IOs because there are no additional nodes to serve as a failover. However, systems and techniques help to ensure that this is still non-disruptive and seamless from the client backup applications' point of view. That is, the backup applications can continue sending requests to the client libraries while the server is unavailable and in the process of being upgraded. The upgrade is transparent to the backup application. The client libraries may hold or buffer the requests while the upgrade is in progress.

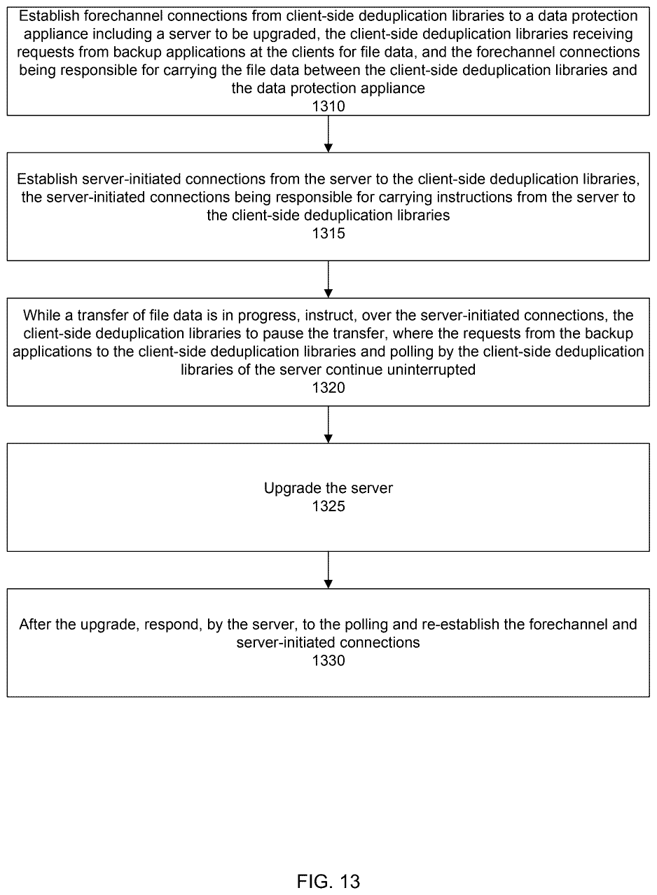

FIG. 13 shows a flow for conducting an upgrade of a single-node appliance. In a step 1310, forechannel connections are established from client-side deduplication libraries at clients to a data protection appliance including a server to be upgraded. The client-side deduplication libraries are responsible for handling requests from backup applications at the clients and interfacing with the appliance to process the requests. The forechannel connections are responsible for carrying the file data between the client-side deduplication libraries and the data protection appliance.

In a step 1315, server-initiated connections are established from the server to the client-side deduplication libraries. The server-initiated connections are responsible for carrying instructions from the server to the client-side libraries.

In a step 1320, while a transfer of file data is in progress, the client-side deduplication libraries are instructed, over the server-initiated connections, to pause the transfer. Requests, however, from the backup applications to the client-side deduplication libraries are allowed to continue uninterrupted. Similarly, polling by the client-side deduplication libraries of the server is allowed to continue uninterrupted.

In a step 1325, the server is upgraded.

In a step 1330, once the upgrade of the server is complete, the server is brought back online. The now upgraded server is thus able to respond to the polling by the client-side deduplication libraries to re-establish the forechannel and server-initiated connections.

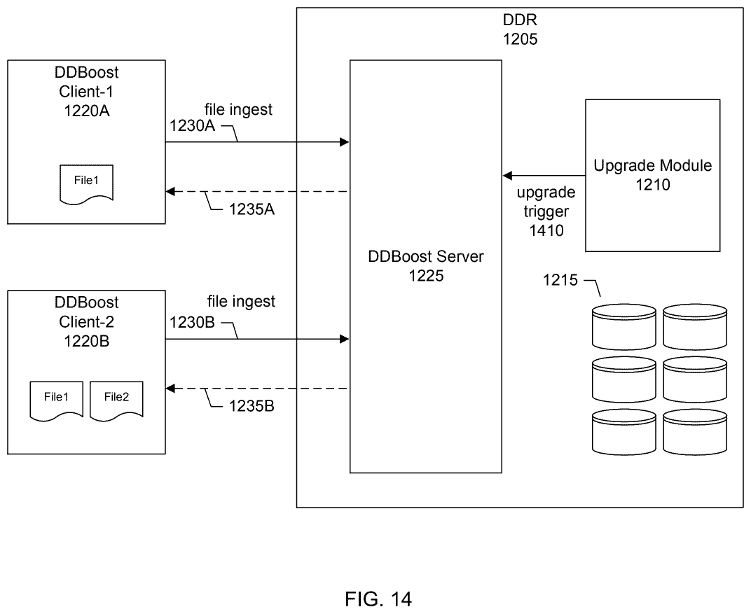

For example, FIG. 14 shows a block diagram of a start of the upgrade process. The upgrade is initiated with the upgrade module sending an upgrade trigger 1410 to the server, e.g., DDBoost server.

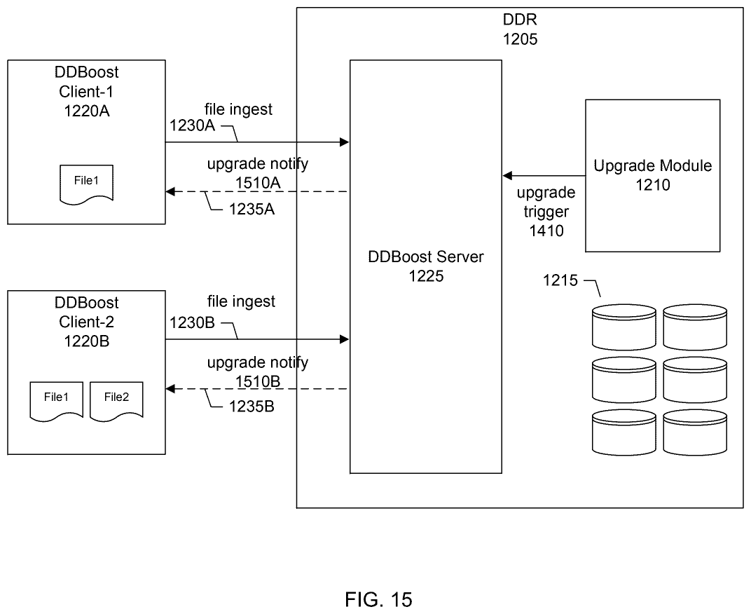

Referring now to FIG. 15, the server upon receiving the upgrade trigger, issues over server-initiated connections 1235A,B upgrade notification messages 1510A,B to client libraries 1220A,B, respectively, that are connected to it.

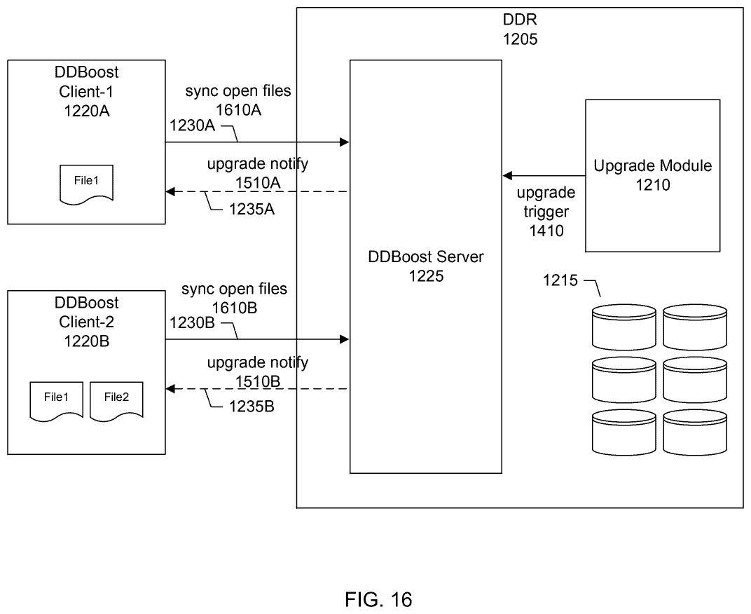

Referring now to FIG. 16, the client libraries, in turn, synchronize 1610A,B any open files with the server.

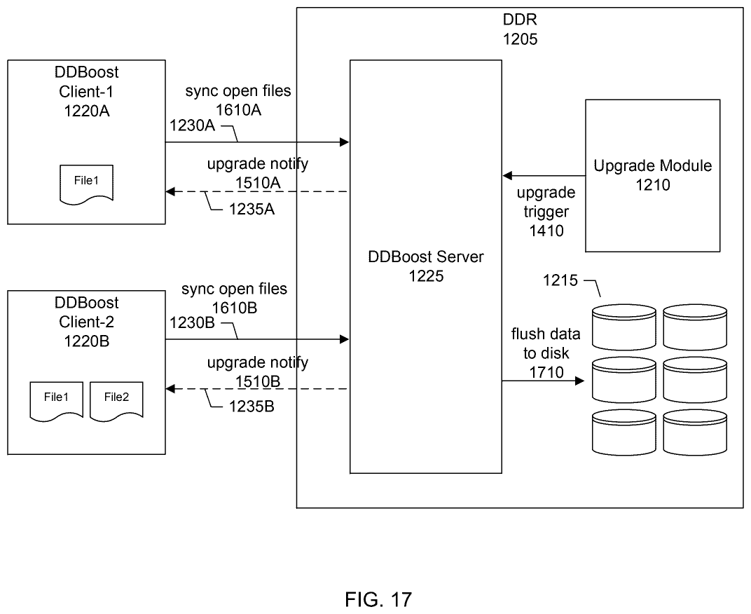

Referring now to FIG. 17, the server responds to the synchronization by flushing 1710 data, e.g., file data, to disk.

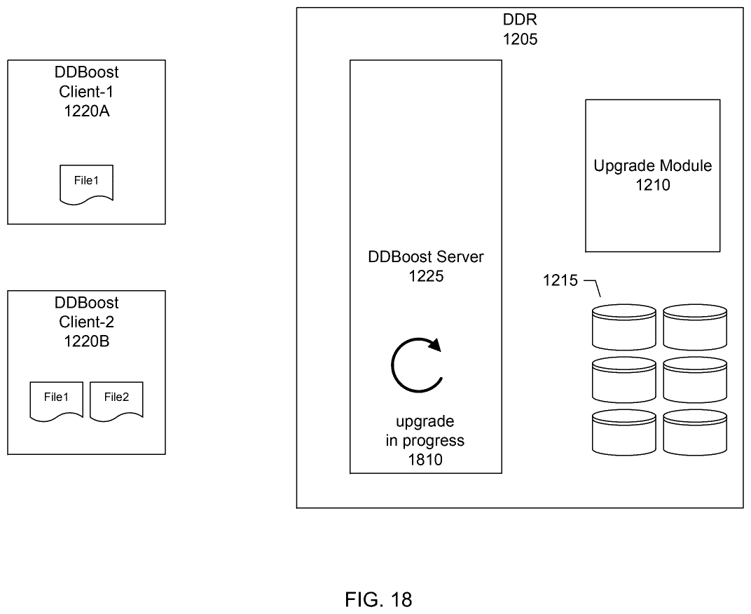

Referring now to FIG. 18, once the server has flushed data to disk, an upgrade 1810 of the server is performed. The upgrade of the server causes a termination of the forechannel and server-initiated connections between the client-side libraries and the server.

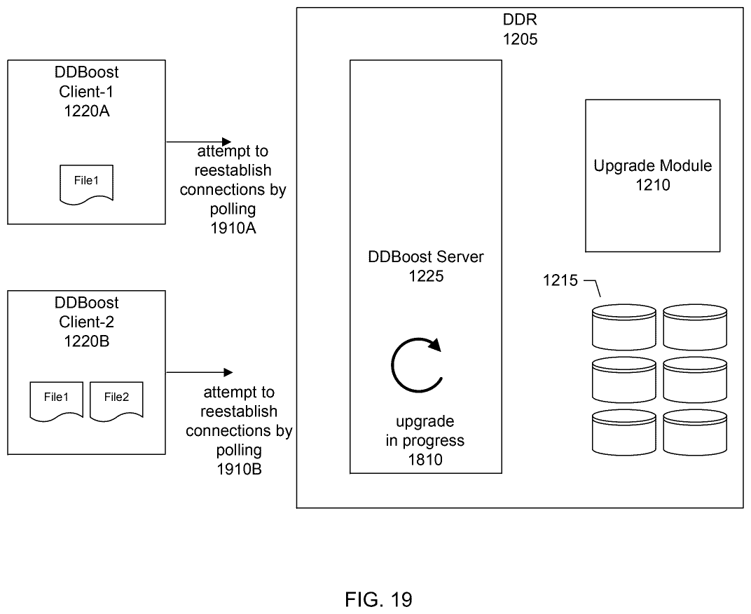

Referring now to FIG. 19, while the upgrade of the server is in progress, the client-side deduplication libraries continue to receive requests from the client backup applications and continue attempts to reestablish connections by polling 1910A,B the server.

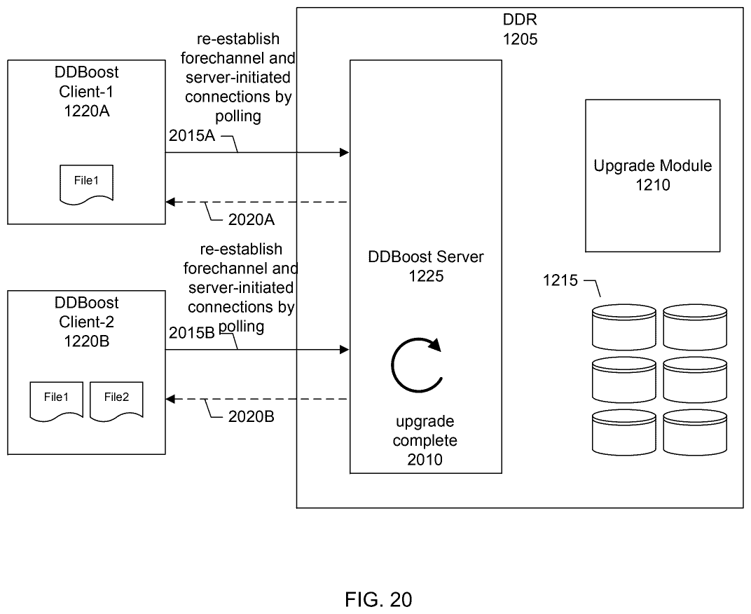

Referring now to FIG. 20, once the server upgrade is complete (2010), forechannel connections 2015A,B and server-initiated connections 2020A,B between the client-side libraries and the server can be reestablished from the polling.

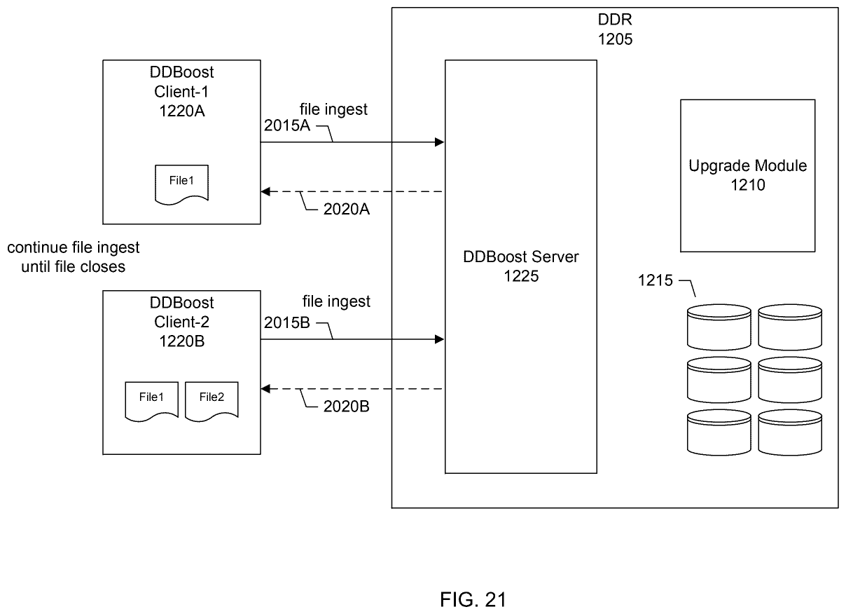

Referring now to FIG. 21, file ingest can now resume or continue with the upgraded server over the reestablished forechannel connections until the files are closed.

Table B below shows further detail of a flow for conducting an upgrade of a single-node filesystem.

TABLE B

| Step | Description |
|---|---|
| 1 | Module initiating upgrade notifies the process (e.g., ddfs) via an intention as upgrade to |
| | disable filesystem |
| 2 | DDBoost Server-initiated Infrastructure starts scheduling messages to all the DDBoost |
| | clients which are connected to this appliance to PAUSE IOs. |
| 3 | DDBoost client upon receipt of the message, performs the following: |
| 4A | Add a barrier and stops issuing any further IOs to the filesystem (e.g., DataDomain). This |
| | can be done by marking node under upgrade. |
| 4B | Stops creating new connection and stops creating new file on the appliance. |
| 4C | Iterates over its array of Connection Descriptors |
| 4D | Iterates over each File Descriptors for particular Connection descriptors |
| 4E | Synchronizes the file but preserves its File Descriptor and does not allow it to be reused. |
| | The close and commit operation triggers a flush of dirty and stale data on the filesystem |
| | side. |
| 4F | Preserves all Connection Descriptors and does not allow that to be reused. |
| 4G | Both connection and file descriptors can be marked with a flag to indicate they are |
| | currently under an upgrade scenario. |
| 4H | This is required as clients will be connecting to multiple appliances and that should not |
| | trigger reuse of any of those descriptors. |
| 4I | This also helps in cases where upgrades are taking more time than the API timeout |
| | duration. DDBoost client can send special error message back to application to indicate |
| | upgrades and ask for retry. |
| 5 | DDBoost client continues to poll and waits for re-establishment server-initiated |
| | connection. |
| 6 | On successful connection: |
| 7A | DDBoost client re-establishes all the Connections that were closed and uses the same |
| | Connection Descriptor that was used earlier before the upgrade. |
| 7B | DDBoost client re-starts opening all the files that were previously opened and uses the |
| | same File Descriptor. |
| 7C | DDBoost client removes the barrier and allows IO to continue and also allows for new |
| | files to be opened. |

The disclosed technique allows the DDBoost client to be aware of the occurrence of an upgrade and allows them to pause IOs on the client-side itself without impacting the backup applications.

In an embodiment, systems and techniques provide for a seamless upgrade. Seamless upgrades can be performed in a clustered filesystem environment, thereby helping to ensure zero downtime. In this embodiment, the filesystem redirector and proxy service is used to notify a failback message to the client-side libraries which avoids polling, by the client-side libraries, for reestablishing the server-initiated connection after upgrade.

In another embodiment, systems and techniques enable the inline deduplication process to resume IOs without disruption in single target appliance configuration.

In another embodiment, upgrade progress may be sent to the backup application via the same server-initiated connections associated with the clustered filesystem.

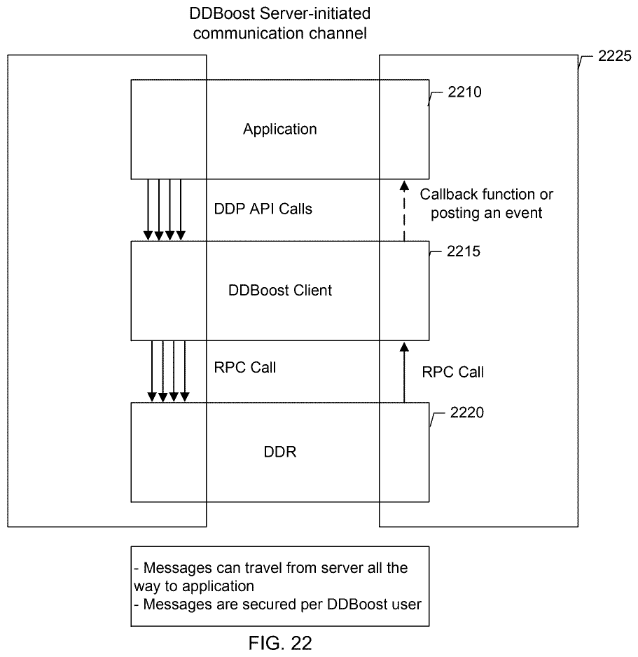

FIG. 22 shows a block diagram of a server-initiated (e.g., DD Boost or server-initiated communication channel) workflow. The example shown in FIG. 22 includes an application 2210 (e.g., client backup application), DD Boost client 2215 (e.g., client-side library), and DDR server 2220. In an embodiment, systems and techniques are provided for secure end-to-end notification of DD Boost server-side events. A typical workflow from a backup application to DDR via a DD Boost client is as follows. An application calls an API referred to as DD API into the DD Boost client and the DD Boost client sends one or more RPCs to DDRs.

In an embodiment, systems and techniques are provided for a protocol that allows server-side events to be sent back to the client and application. In an embodiment, the connection protocol is referred to as a server-initiated communication channel 2225. The server-initiated channel is used for cases where callback requests from DDR to DD Boost clients are required. Messages can travel from the server (e.g., DDR) to the DD Boost client to the application. The messages are secured for each DD Boost user.

In various embodiments, systems and techniques are provided for end-to-end and secured events messaging for client, authenticated user or storage unit specific events; mechanisms allowing file system level subsystems to use the server-initiated channel to deliver events; delivering messages back to either one client or multiple clients or all the clients; processing dead (or hung up) messages; and for switching between an existing connection to receive a server-initiated communication message on the client (without needing to have sessions).

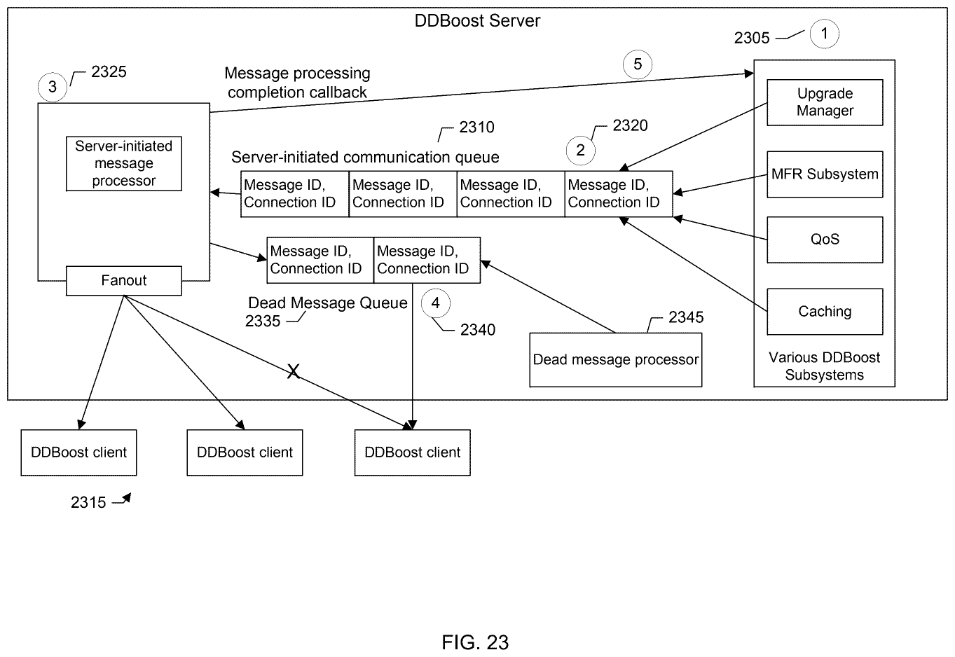

FIG. 23 shows a block diagram illustrating an overview of a DD Boost server-side implementation. In a first step 2305, various DD Boost/file system subsystems enqueue messages to a server-initiated message queue 2310 whenever they want to send out a message to a DD Boost client 2315 (e.g., client-side library or backup application). Some examples of events include MFR job completion, DD is undergoing upgrades, feature toggle change, QoS, and the like. A further listing of use cases are provided in a later discussion. The subsystem is able to register a callback that can be called back when the delivery of the message is successful. The subsystems are able to cancel the message at any point of time until the callback is not called. Cancelling of the message will only cancel the outstanding messages and not the ones which are being processed. Such subsystems can call an API to enqueue the message with the information such as message ID, message data, client identifier and callback function if required. Client identifier is specified in such a way to distinguish whether the message needs to be delivered to single client or multiple clients or all the clients.

In a second step 2320, the server-initiated message queue holds all the outstanding messages that need to be sent to the one client or multiple clients. In an embodiment, the queue is an ordered queue.

In a third step 2325, a server-initiated message processor 2330 retrieves messages from the server-initiated message queue and sends out messages to the DD Boost client. DD Boost server on DD maintains a pool of connections which are marked for server-initiated messages. In order to identify clients uniquely, the DD Boost client sends a unique ID per client instance to the DD Boost server. The server-initiated message processor iterates over the RPC connections and stores private data about the server-initiated message, UserID, StorageUnit, and the like at the RPC layer.

While sending RPC messages back to the client, the server-initiated message processor as shown in FIG. 23 calls the RPC layer helper function to find out all the current connections and filter out connections where an RPC message needs to be sent back based on the message and extra information stored per connection. It then invokes the RPC layer calls to send the message on the wire. If the message is undelivered, it is added to a dead message queue 2335.

In a fourth step 2340, the dead message queue is used for the retry mechanism. This ensures that primary messages are not logged because of unresponsive clients. A dead message processor 2345 works on the dead message queue to continue retry based on a configurable retry count and retry timeouts before abandoning sending out the message.

Table C below shows an example of an RPC server-initiated message.

```
TABLE C
// Server-initiated communication message that is submitted by subsystem
to DDBoost Server-initiated communication Message Queue
typedef struct rpc_server-initiated_msg {
    int msg_type; //ALL_CLIENTS, SPECIFIC_CLIENT
    int stack_id; //connection identifier or 0xffffffff to indicate all clients
  unique_id_t client_id; // client ID or 0xffffffff
    int msg_number; //RPC message number
    union { RPC message data};
};
// RPC message which will travel on the wire from DDBoost Server to
DDBoost client typedef struct rpc_server-initiated_msg {
    int msg_type;
    int msg_number; //RPC message number
    union { RPC message data};
};
```

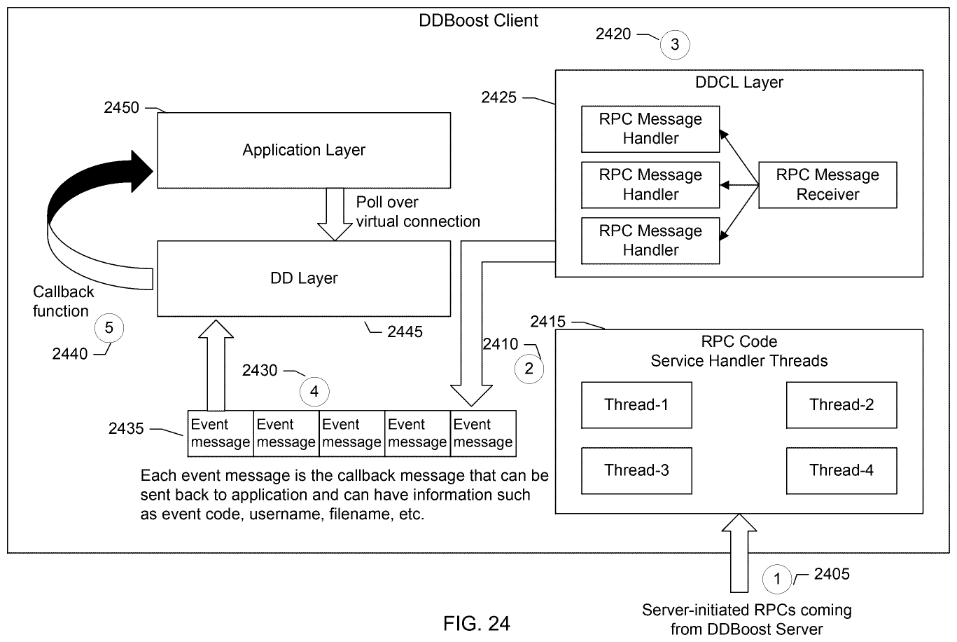

FIG. 24 shows a block diagram illustrating an overview of a DD Boost client-side implementation. In a first step 2405, server-initiated RPC messages are received by an RPC layer on the client-side.

In a second step 2410, DD Boost client-side RPC code receives server-initiated messages from the server. Service handler threads 2415 will start processing them. It is not expected to be receiving hundreds of messages at the same time. So, four or about four RPC threads will be enough to be allocated statically for server-initiated message processing.

In a third step 2420, DDCL layer message handlers 2425 conduct RPC message specific processing. These message handlers are defined per RPC message. And a subsequent processing required for a particular message is performed in the DDCL layer.

In a fourth step 2430, an event queue 2435 holds the events that need to be sent back to the backup applications. Once the DDCL layer message handler processes the server-initiated message, it can determine if this also needs to be notified to the backup applications (e.g., MFR job completion status). In such scenario, it posts a relevant message to the event queue. The DDCL layer also converts server-initiated message data into application specific data such as including connection and user identifier in the event.

In a fifth step 2440, a DD layer 2445 can implement a generic callback message that is called into an application space 2450. This notifies the application that there are events that the application can consume. An application can then poll for the events via a DD Boost API.

In an embodiment, server-initiated communication channel creation is driven via DD Boost clients. This is desirable as the DD Boost client does not need to listen on any port and such a requirement is not practically feasible as customers may not want to open any ports in their environment. This also allows driving server-initiated communication channel creation via a DD Boost API and for an application specific scenario. The DD Boost client can also decide when it wants to create server-initiated communication connection channel or wants to reuse some connection depending on the different application specific environment in which it is working.

The DD Boost client makes a physical TCP connection with the DD Boost server and dedicates that the connection to be used only for server-initiated messages via a technique as described below.

Since the server-initiated channel is per client and per DDR, the connection has to be established during the first physical connection from client to DD and should be closed during the last connection close from client to DD. However, when the connection is established, DD still does not know whether a channel is being used for regular RPCs or for server-initiated communication RPCs. Thus, a new RPC is introduced to indicate the same.

Table D below shows an example of an RPC to indicate establishment of a server-initiated communication channel.

```
TABLE D
#define USE_CONN_AS_SERVER-INITIATED 1
struct dd_conn_type_args_v1 {
  dd_uint32_t rpc_version;
  dd_connection_flag flag;
  string clientid<>; // can be IP address or some client specific name
};
union dd_conn_type_args switch (dd_rpc_version rpc_version) {
  case DD_RPC_VERSION_1:
    dd_conn_type_args_v1 v1;
  default:
    void;
};
struct dd_conn_type_res_v1_ok {
  dd_uint32_t rpc_version;
};
struct dd_conn_type_res_fail {
  dd_err_t err;
  dd_uint32_t rpc_version;
};
union dd_conn_type_res_v1 switch(nfsstat3 status){
  case NFS3_OK:
    dd_conn_type_res_v1_ok resok;
  default:
    dd_conn_type_res_fail resfail;
};
union dd_conn_type_res switch (dd_rpc_version rpc_version) {
  case DD_RPC_VERSION_1:
    dd_conn_type_res_v1 v1;
  default:
    void;
};
```

In an embodiment, the above RPC is sent during a connection sequence immediately after an authentication sequence completes. In other embodiments, the client can choose to send the new RPC any time. Once the DD Boost server receives this RPC, it allocates resources for the server-initiated communication channel. Once the resources are successfully allocated, the DD Boost server responds back to the client. DD Boost client should be ready to receive RPCs from the DD Boost server at this point. This also means that the DD Boost client should first allocate its own resources before sending the above RPC to DD Boost server.

The DD Boost server can also choose to return a failure should there be cases where insufficient resources are available or any other error scenarios.

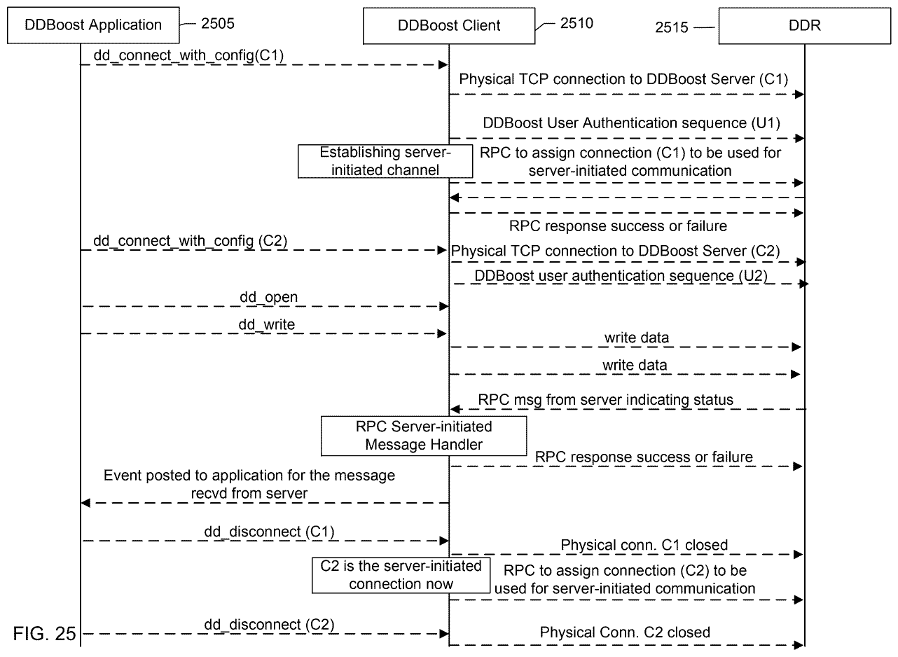

FIG. 25 shows a sequence diagram for server-initiated communication channel connection and disconnection. The sequence of when a server-initiated communication connection is established and destroyed is shown in FIG. 25. The sequence diagram shown in FIG. 25 includes a DD Boost application 2505 (e.g., backup application), a DD Boost client 2510, and a DDR 2515. The DD Boost client manages which connection is used for a server-initiated communication channel connection with each DD Boost server it connects to. It may manage an array or pool of connections identifiers for all the connections to the DD Boost server. It adds an enum/flag to indicate the connection is also used for a server-initiated communication channel.

In case of a connection getting terminated and that connection was also marked for use as a server-initiated communication connection, it will review the established connection pool and find another connection that can now be used as a server-initiated communication connection as part of the termination sequence.

The DD Boost client sends a similar RPC message to indicate a new connection to be used for server-initiated communication channel messages. The DD Boost server does not need to perform any specific actions other than adding the same to the pool of connections it is managing and mark that connection where it should send the server-initiated communication channel messages. DD Boost client ensures that it always sends the same unique client ID for the connection sequence of the same client instance.

In an embodiment, systems and techniques provide for a server-initiated feature toggle. A feature toggle on the DD Boost server side allows for addressing any unforeseeable bug in a customer's environment. When such feature is toggled off, the DD Boost server can return an appropriate error for the RPC as described above.

In an embodiment, systems and techniques provide for multiple connections per client. In an embodiment, the DD Boost client makes multiple connections to the DD Boost server depending on the scenarios. The DD Boost client can use the above mechanism to also dedicate or assign multiple connections as a server-initiated connection. The DD Boost client can choose to make few connections shared for server-initiated communication channel events. This is decided based on the number of “different” users connecting to the server. This can also depend on encryption being used across various connections. The server-initiated communication connection inherits the properties of the original connection being made by an application.

In an embodiment, systems and techniques provide for an RPC transfer mechanism. There can be multiple approaches that can be implemented to send an RPC message from server to client as described in the following. In a first approach, the DD Boost server sends server-initiated message using an RPC or gRPC mechanism. The DD Boost server acts as a client to send out RPC message and the client includes service handlers defined to service the incoming RPC messages. The remaining processing is as shown in FIG. 24 and described in the discussion accompanying FIG. 24.

In a second approach, the client sends RPC messages on the server-side during initialization of connection and will not expect an immediate reply from the server. The server can respond to the messages and when it has a message/event to send back to the client. The client then processes the reply as an incoming message by examining the “data” embedded in there. Once the processing is complete, it posts the new RPC message back to the DD Boost server along with the result of previously posted message. Both client and server can also embed message ID to determine the status.

In an embodiment, a method includes: establishing forechannel connections from client-side deduplication libraries at clients to a namespace node of a plurality of namespace nodes formed as a cluster, the namespace nodes being responsible for namespace operations on files managed by a deduplication file system, and the forechannel connections being responsible for carrying file data between the client-side deduplication libraries and the namespace node; establishing server-initiated connections from the namespace node to the client-side deduplication libraries, the server-initiated connections being responsible for carrying instructions from the namespace node to the client-side deduplication libraries; while a transfer of the file data is in progress, instructing, over the server-initiated connections, the client-side deduplication libraries to failover the transfer to one or more other namespace nodes; and after the failover, upgrading the namespace node.

The method may include: upon completing the upgrade, instructing the client-side deduplication libraries to failback the transfer to the upgraded namespace node. In an embodiment, the server-initiated connections are first server-initiated connections and the method further comprises: establishing second server-initiated connections between a file system redirector and proxy (FSRP) service of the deduplication file system and the client-side deduplication libraries; during the upgrade, maintaining the second server-initiated connections between the FSRP service and the client-side deduplication libraries while the first server-initiated connections are terminated because of the upgrade; discovering, by the FSRP service, that the upgrade of the namespace node has completed; and upon the discovery, transmitting, by the FSRP service, a remote procedure call (RPC) message over the second server-initiated connections to the client-side deduplication libraries notifying the client-side deduplication libraries that the upgrade has completed.

The method may include: upon the client-side deduplication libraries receiving the instruction to failover, marking the namespace node as unavailable, the unavailability of the namespace node thereby having been determined from the instruction to failover and not via polling the namespace node.

In an embodiment, a first transfer of first file data between a first client-side deduplication library and the namespace node to be upgraded fails over to a first failover namespace node, and a second transfer of second file data between a second client-side deduplication library and the namespace node to be upgraded fails over to a second failover namespace node, different from the first failover namespace node.

In an embodiment, the clients comprise client applications communicating with the client-side deduplication libraries for data protection operations on files requested by the client applications and managed by the deduplication file system, and the method further comprises: presenting to the client applications connection descriptors and file descriptors for the files that are the same before and after the upgrade, thereby allowing the upgrade to be transparent to the client applications.

In another embodiment, there is a system comprising: a processor; and memory configured to store one or more sequences of instructions which, when executed by the processor, cause the processor to carry out the steps of: establishing forechannel connections from client-side deduplication libraries at clients to a namespace node of a plurality of namespace nodes formed as a cluster, the namespace nodes being responsible for namespace operations on files managed by a deduplication file system, and the forechannel connections being responsible for carrying file data between the client-side deduplication libraries and the namespace node; establishing server-initiated connections from the namespace node to the client-side deduplication libraries, the server-initiated connections being responsible for carrying instructions from the namespace node to the client-side deduplication libraries; while a transfer of the file data is in progress, instructing, over the server-initiated connections, the client-side deduplication libraries to failover the transfer to one or more other namespace nodes; and after the failover, upgrading the namespace node.

In another embodiment, there is a computer program product, comprising a non-transitory computer-readable medium having a computer-readable program code embodied therein, the computer-readable program code adapted to be executed by one or more processors to implement a method comprising: establishing forechannel connections from client-side deduplication libraries at clients to a namespace node of a plurality of namespace nodes formed as a cluster, the namespace nodes being responsible for namespace operations on files managed by a deduplication file system, and the forechannel connections being responsible for carrying file data between the client-side deduplication libraries and the namespace node; establishing server-initiated connections from the namespace node to the client-side deduplication libraries, the server-initiated connections being responsible for carrying instructions from the namespace node to the client-side deduplication libraries; while a transfer of the file data is in progress, instructing, over the server-initiated connections, the client-side deduplication libraries to failover the transfer to one or more other namespace nodes; and after the failover, upgrading the namespace node.

In an embodiment, a method includes: establishing forechannel connections from client-side deduplication libraries at clients to a data protection appliance comprising a server to be upgraded, the client-side deduplication libraries receiving requests from backup applications at the clients for file data, and the forechannel connections being responsible for carrying the file data between the client-side deduplication libraries and the data protection appliance; establishing server-initiated connections from the server to the client-side deduplication libraries, the server-initiated connections being responsible for carrying instructions from the server to the client-side deduplication libraries; while a transfer of the file data is in progress, instructing, over the server-initiated connections, the client-side deduplication libraries to pause the transfer for the server upgrade while allowing the requests from the backup applications to the client-side deduplication libraries to continue uninterrupted; upon the pausing, upgrading the server; and after the server has been upgraded, re-establishing the forechannel and server-initiated connections.

In an embodiment, the client-side deduplication libraries continue to poll the server during the upgrade. The method may include: presenting to the backup applications connection descriptors and file descriptors for files associated with the file data; upon receiving the instruction to pause, flagging the connection descriptors and the file descriptors to prevent the connection and file descriptors from being invalidated; maintaining a mapping of the files to the connection and the file descriptors; and closing the files and connections to the server; and reusing the same connection descriptors and file descriptors for the files after the upgrade.

In an embodiment, the method further includes: providing a backup application with a connection descriptor and a file descriptor for a file managed by the data protection appliance and requested by the backup application; upon receiving the instruction to pause, flagging the connection descriptor and the file descriptor to prevent the descriptors from being reused during the upgrade; after the upgrade, reopening a connection to the now upgraded server, reopening the file, and using the previously flagged connection descriptor and file descriptor for the respective reopened connection and reopened file. Re-establishing the forechannel and server-initiated connections may include responding, by the now upgraded server, to polling by the client-side deduplication libraries. In an embodiment, the method further includes: upon receiving the instruction, synchronizing files that are open with the data protection appliance.

In another embodiment, there is a system comprising: a processor; and memory configured to store one or more sequences of instructions which, when executed by the processor, cause the processor to carry out the steps of: establishing forechannel connections from client-side deduplication libraries at clients to a data protection appliance comprising a server to be upgraded, the client-side deduplication libraries receiving requests from backup applications at the clients for file data, and the forechannel connections being responsible for carrying the file data between the client-side deduplication libraries and the data protection appliance; establishing server-initiated connections from the server to the client-side deduplication libraries, the server-initiated connections being responsible for carrying instructions from the server to the client-side deduplication libraries; while a transfer of the file data is in progress, instructing, over the server-initiated connections, the client-side deduplication libraries to pause the transfer for the server upgrade while allowing the requests from the backup applications to the client-side deduplication libraries to continue uninterrupted; upon the pausing, upgrading the server; and after the server has been upgraded, re-establishing the forechannel and server-initiated connections.

In another embodiment, there is a computer program product, comprising a non-transitory computer-readable medium having a computer-readable program code embodied therein, the computer-readable program code adapted to be executed by one or more processors to implement a method comprising: establishing forechannel connections from client-side deduplication libraries at clients to a data protection appliance comprising a server to be upgraded, the client-side deduplication libraries receiving requests from backup applications at the clients for file data, and the forechannel connections being responsible for carrying the file data between the client-side deduplication libraries and the data protection appliance; establishing server-initiated connections from the server to the client-side deduplication libraries, the server-initiated connections being responsible for carrying instructions from the server to the client-side deduplication libraries; while a transfer of the file data is in progress, instructing, over the server-initiated connections, the client-side deduplication libraries to pause the transfer for the server upgrade while allowing the requests from the backup applications to the client-side deduplication libraries to continue uninterrupted; upon the pausing, upgrading the server; and after the server has been upgraded, re-establishing the forechannel and server-initiated connections.

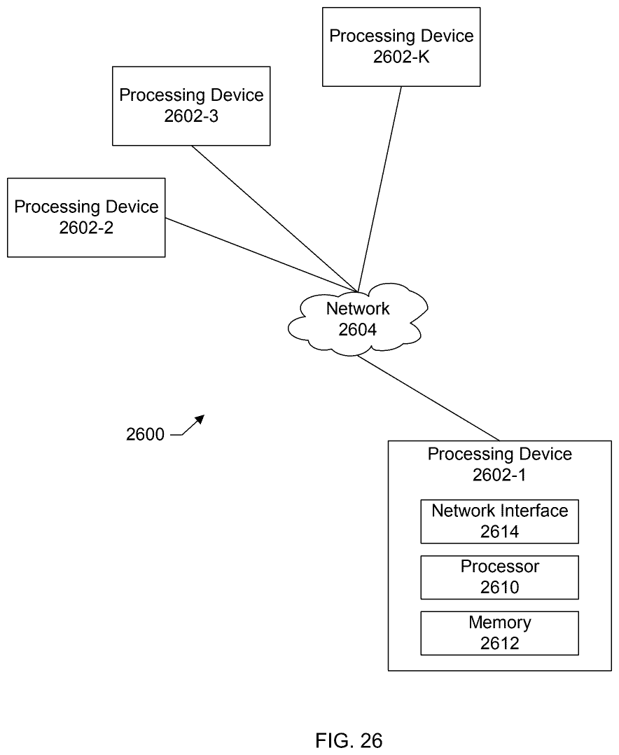

FIG. 26 shows an example of a processing platform 2600 that may include at least a portion of the information handling system shown in FIG. 1. The example shown in FIG. 26 includes a plurality of processing devices, denoted 2602-1, 2602-2, 2602-3, . . . 2602-K, which communicate with one another over a network 2604.

The network 2604 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 2602-1 in the processing platform 2600 comprises a processor 2610 coupled to a memory 2612.

The processor 2610 may comprise a microprocessor, a microcontroller, an application-specific integrated circuit (ASIC), a field-programmable gate array (FPGA) or other type of processing circuitry, as well as portions or combinations of such circuitry elements.

The memory 2612 may comprise random access memory (RAM), read-only memory (ROM) or other types of memory, in any combination. The memory 2612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 2602-1 is network interface circuitry 2614, which is used to interface the processing device with the network 2604 and other system components, and may comprise conventional transceivers.

The other processing devices 2602 of the processing platform 2600 are assumed to be configured in a manner similar to that shown for processing device 2602-1 in the figure.

Again, the particular processing platform 2600 shown in the figure is presented by way of example only, and the information handling system may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxRack™ FLEX, VxBlock™, or Vblock® converged infrastructure from VCE, the Virtual Computing Environment Company, now the Converged Platform and Solutions Division of Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality of one or more components of the compute services platform 100 are illustratively implemented in the form of software running on one or more processing devices.

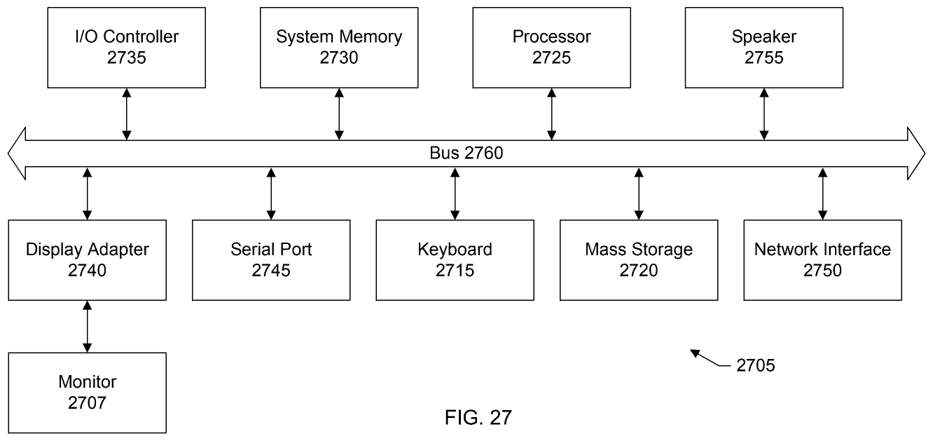

FIG. 27 shows a system block diagram of a computer system 2705 used to execute the software of the present system described herein. The computer system includes a monitor 2707, keyboard 2715, and mass storage devices 2720. Computer system 2705 further includes subsystems such as central processor 2725, system memory 2730, input/output (I/O) controller 2735, display adapter 2740, serial or universal serial bus (USB) port 2745, network interface 2750, and speaker 2755. The system may also be used with computer systems with additional or fewer subsystems. For example, a computer system could include more than one processor 2725 (i.e., a multiprocessor system) or a system may include a cache memory.

Arrows such as 2760 represent the system bus architecture of computer system 2705. However, these arrows are illustrative of any interconnection scheme serving to link the subsystems. For example, speaker 2755 could be connected to the other subsystems through a port or have an internal direct connection to central processor 2725. The processor may include multiple processors or a multicore processor, which may permit parallel processing of information. Computer system 2705 shown in FIG. 27 is but an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system may be one of the Microsoft Windows®. family of systems (e.g., Windows Server), Linux, Mac OS X, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, 802.11n, 802.11ac, and 802.11ad, just to name a few examples), near field communication (NFC), radio-frequency identification (RFID), mobile or cellular wireless. For example, signals from a computer may be transferred, at least in part, wirelessly to components or other computers.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment. Other embodiments include systems and non-volatile media products that execute, embody or store processes that implement the methods described above.

What is claimed is:

1. A method comprising:
establishing forechannel connections from client-side deduplication libraries at clients to a namespace node of a plurality of namespace nodes formed as a cluster, the namespace nodes being responsible for namespace operations on files managed by a deduplication file system, and the forechannel connections being responsible for carrying file data between the client-side deduplication libraries and the namespace node;
establishing server-initiated connections from the namespace node to the client-side deduplication libraries, the server-initiated connections being responsible for carrying instructions from the namespace node to the client-side deduplication libraries;
while a transfer of the file data is in progress, instructing, over the server-initiated connections, the client-side deduplication libraries to failover the transfer to one or more other namespace nodes; and
after the failover, upgrading the namespace node.

2. The method of claim 1 further comprising:
upon completing the upgrade, instructing the client-side deduplication libraries to failback the transfer to the upgraded namespace node.

3. The method of claim 1 wherein the server-initiated connections are first server-initiated connections and the method further comprises:
establishing second server-initiated connections between a file system redirector and proxy (FSRP) service of the deduplication file system and the client-side deduplication libraries;
during the upgrade, maintaining the second server-initiated connections between the FSRP service and the client-side deduplication libraries while the first server-initiated connections are terminated because of the upgrade;
discovering, by the FSRP service, that the upgrade of the namespace node has completed; and
upon the discovery, transmitting, by the FSRP service, a remote procedure call (RPC) message over the second server-initiated connections to the client-side deduplication libraries notifying the client-side deduplication libraries that the upgrade has completed.

4. The method of claim 1 further comprising:
upon the client-side deduplication libraries receiving the instruction to failover, marking the namespace node as unavailable, the unavailability of the namespace node thereby having been determined from the instruction to failover and not via polling the namespace node.

5. The method of claim 1 wherein a first transfer of first file data between a first client-side deduplication library and the namespace node to be upgraded fails over to a first failover namespace node, and
wherein a second transfer of second file data between a second client-side deduplication library and the namespace node to be upgraded fails over to a second failover namespace node, different from the first failover namespace node.

6. The method of claim 1 wherein the clients comprise client applications communicating with the client-side deduplication libraries for data protection operations on files requested by the client applications and managed by the deduplication file system, and the method further comprises:
presenting to the client applications connection descriptors and file descriptors for the files that are the same before and after the upgrade, thereby allowing the upgrade to be transparent to the client applications.

7. A system comprising: a processor; and memory configured to store one or more sequences of instructions which, when executed by the processor, cause the processor to carry out the steps of:
establishing forechannel connections from client-side deduplication libraries at clients to a namespace node of a plurality of namespace nodes formed as a cluster, the namespace nodes being responsible for namespace operations on files managed by a deduplication file system, and the forechannel connections being responsible for carrying file data between the client-side deduplication libraries and the namespace node;
establishing server-initiated connections from the namespace node to the client-side deduplication libraries, the server-initiated connections being responsible for carrying instructions from the namespace node to the client-side deduplication libraries;
while a transfer of the file data is in progress, instructing, over the server-initiated connections, the client-side deduplication libraries to failover the transfer to one or more other namespace nodes; and
after the failover, upgrading the namespace node.

8. The system of claim 7 wherein the processor further carries out the step of:
upon completing the upgrade, instructing the client-side deduplication libraries to failback the transfer to the upgraded namespace node.

9. The system of claim 7 wherein the server-initiated connections are first server-initiated connections and the processor further carries out the steps of:
establishing second server-initiated connections between a file system redirector and proxy (FSRP) service of the deduplication file system and the client-side deduplication libraries;
during the upgrade, maintaining the second server-initiated connections between the FSRP service and the client-side deduplication libraries while the first server-initiated connections are terminated because of the upgrade;
discovering, by the FSRP service, that the upgrade of the namespace node has completed; and
upon the discovery, transmitting, by the FSRP service, a remote procedure call (RPC) message over the second server-initiated connections to the client-side deduplication libraries notifying the client-side deduplication libraries that the upgrade has completed.

10. The system of claim 7 wherein the processor further carries out the step of:
upon the client-side deduplication libraries receiving the instruction to failover, marking the namespace node as unavailable, the unavailability of the namespace node thereby having been determined from the instruction to failover and not via polling the namespace node.

11. The system of claim 7 wherein a first transfer of first file data between a first client-side deduplication library and the namespace node to be upgraded fails over to a first failover namespace node, and
wherein a second transfer of second file data between a second client-side deduplication library and the namespace node to be upgraded fails over to a second failover namespace node, different from the first failover namespace node.

12. The system of claim 7 wherein the clients comprise client applications communicating with the client-side deduplication libraries for data protection operations on files requested by the client applications and managed by the deduplication file system, and the processor further carries out the step of:
presenting to the client applications connection descriptors and file descriptors for the files that are the same before and after the upgrade, thereby allowing the upgrade to be transparent to the client applications.

13. A computer program product, comprising a non-transitory computer-readable medium having a computer-readable program code embodied therein, the computer-readable program code adapted to be executed by one or more processors to implement a method comprising:
establishing forechannel connections from client-side deduplication libraries at clients to a namespace node of a plurality of namespace nodes formed as a cluster, the namespace nodes being responsible for namespace operations on files managed by a deduplication file system, and the forechannel connections being responsible for carrying file data between the client-side deduplication libraries and the namespace node;
establishing server-initiated connections from the namespace node to the client-side deduplication libraries, the server-initiated connections being responsible for carrying instructions from the namespace node to the client-side deduplication libraries;
while a transfer of the file data is in progress, instructing, over the server-initiated connections, the client-side deduplication libraries to failover the transfer to one or more other namespace nodes; and
after the failover, upgrading the namespace node.

14. The computer program product of claim 13 wherein the method further comprises:
upon completing the upgrade, instructing the client-side deduplication libraries to failback the transfer to the upgraded namespace node.

15. The computer program product of claim 13 wherein the server-initiated connections are first server-initiated connections and the method further comprises:
establishing second server-initiated connections between a file system redirector and proxy (FSRP) service of the deduplication file system and the client-side deduplication libraries;
during the upgrade, maintaining the second server-initiated connections between the FSRP service and the client-side deduplication libraries while the first server-initiated connections are terminated because of the upgrade;
discovering, by the FSRP service, that the upgrade of the namespace node has completed; and
upon the discovery, transmitting, by the FSRP service, a remote procedure call (RPC) message over the second server-initiated connections to the client-side deduplication libraries notifying the client-side deduplication libraries that the upgrade has completed.

16. The computer program product of claim 13 wherein the method further comprises:
upon the client-side deduplication libraries receiving the instruction to failover, marking the namespace node as unavailable, the unavailability of the namespace node thereby having been determined from the instruction to failover and not via polling the namespace node.

17. The computer program product of claim 13 wherein a first transfer of first file data between a first client-side deduplication library and the namespace node to be upgraded fails over to a first failover namespace node, and
wherein a second transfer of second file data between a second client-side deduplication library and the namespace node to be upgraded fails over to a second failover namespace node, different from the first failover namespace node.

18. The computer program product of claim 13 wherein the clients comprise client applications communicating with the client-side deduplication libraries for data protection operations on files requested by the client applications and managed by the deduplication file system, and the method further comprises:
presenting to the client applications connection descriptors and file descriptors for the files that are the same before and after the upgrade, thereby allowing the upgrade to be transparent to the client applications.
